(19) United States
(12) Patent Application Publication
(10) Pub. No.: US 2022/0164833 A1
(43) Pub. Date: May 26, 2022

(54) PORTABLE EVALUATION DEVICE, ASSOCIATED SYSTEMS AND METHODS, AND RESUMABLE EVALUATION SESSIONS

(71) Applicant: A La Carte Media, Inc., Saint-Laurent, Q.C. (CA)

(72) Inventors: Dominique Dion, Montreal (CA); Tony Mastronardi, Montreal (CA)

(21) Appl. No.: 17/534,092

(22) Filed: Nov. 23, 2021

Related U.S. Application Data
(63) Continuation-in-part of application No. PCT/IB2021/059990, filed on Oct. 28, 2021.
Application No. PCT/IB2021/059990 is a continuation-in-part of application No. PCT/IB2021/059989, filed on Oct. 28, 2021.
(60) Provisional application No. 63/117,346, filed on Nov. 23, 2020.

(51) Int. Cl. G06Q 30/02; G06Q 10/00; H04W 4/70; H04W 4/20; G06V 10/94

(52) U.S. Cl. CPC G06Q 30/0278; G06Q 10/20; G06V 10/95; H04W 4/20; H04W 4/70

(57) ABSTRACT

A portable evaluation device for at least partially evaluating a pre-owned electronic device is described. An evaluation app executing on the portable electronic device communicates with a diagnostic app executing on the pre-owned electronic device perform the at least partial evaluation of the pre-owned electronic device. The portable evaluation device may be used with or without being associated with an evaluation kiosk.

### CROSS-REFERENCE TO RELATED APPLICATIONS

This application is a continuation-in-part of PCT Application No. PCT/IB2021/059990 filed Oct. 28, 2021, which claims the benefit of priority from U.S. Provisional Application No. 63/106,655 filed on Oct. 28, 2020, the entire content of which is incorporated herein by reference. This application also claims the benefit of priority from U.S. Provisional Application No. 63/117,346 filed on Nov. 23, 2020, and the benefit of priority from PCT Application No. PCT/IB2021/059989 filed on Oct. 28, 2021. The disclosures of PCT/IB2021/059990, PCT/IB2021/059989 and U.S. Provisional Application No. 63/117,346, are herein incorporated by reference in their respective entireties.

### FIELD OF THE TECHNOLOGY

This disclosure is directed to evaluation of pre-owned electronic devices by performing at least a part the evaluation using a portable electronic device. More particularly, the disclosed technology provides for performing at least part of the evaluation of a pre-owned electronic device using a portable electronic device.

### BACKGROUND

Small electronic devices such as smartphones, tablet computers, smart watches, etc. are in widespread use. These small consumer electronic devices may be collectively referred to herein as “pre-owned electronic devices”, “pre-owned devices” or “PODs”. With increased use among all segments of the populations, numerous services and other applications are frequently released by various entities to be performed or used on such devices. Also, the hardware and/or software of these devices are frequently upgraded in the form of new devices being released by manufacturers.

U.S. patent application Ser. No. 15/598,004 filed on May 17, 2017 (“'004 Application”), U.S. patent application Ser. No. 15/153,137 filed on May 12, 2016 (“'137 Application”), PCT Application No. PCT/IB2018/055218, filed on Jul. 13, 2018 (“'218 Application”), PCT Application No. PCT/IB2018/055219, and Jul. 13, 2018 (“'219 Application”), PCT Application No. PCT/IB2019/056533 filed on Jul. 31, 2019 (“533 Application”), and U.S. application Ser. No. 17/071,717, filed on Oct. 15, 2020 (“'717 Application”), the entire contents of which are hereby incorporated by reference in their entireties, describe systems and techniques for distributed collection centers, such as collection kiosks (herein sometimes also referred to as “booths”) that are configured to accept a POD such as a client's smartphone (or other consumer electronic device) and to then provide the client with an amount of money corresponding to an estimated value. Such systems and techniques enable many people who find themselves in situations where, after having bought a new smartphone or some other consumer electronic device to replace an older device, would like to conveniently and safely dispose of the old device. In many instances, such persons may desire to trade the old device in return for some monetary or other gain.

### BRIEF DESCRIPTION OF THE DRAWINGS

FIG. 1 illustrates an evaluation services environment for a previously-owned device, including an evaluation system incorporating a portable evaluation device, according to some embodiments.

FIG. 2 shows an example interface allowing selecting of a mode for a dual mode application (diagnose and evaluate) according to some embodiments.

FIGS. 3A-3F show example interfaces on the portable evaluation device (a tablet, in illustration) and on the previously-owned device (a smartphone, in illustration) at the start of the evaluation, according to some embodiments.

FIGS. 4-7 illustrates various overlaid images shown on the portable evaluation device—instructing the user to rotate or move the device to a specific position and angle in accordance with some embodiments.

FIG. 8 shows example interfaces enhancing instructions using 3D sensors, according to some embodiments.

FIGS. 9 and 10 show example overlays with side identifiers (Top/Bottom/Left/Right) that can be recognized by computer vision/OCR techniques; alternatively, QR codes or other computer recognizable side identifiers may be used.

FIGS. 11-14 shows example interfaces enhancing instructions using 3D sensors, according to some embodiments.

FIG. 15 shows a screen on the portable evaluation device showing evaluation details, according to some embodiments.

FIG. 16 shows a flowchart of an evaluation process according to some example embodiments.

FIG. 17 shows an example of user-interface (UX) flow for relayed and resumable pre-owned electronic device evaluation, according to some example embodiments.

FIG. 18 shows an example of a sequence and example entity interactions involved in relayed and resumable pre-owned electronic device evaluation, according to some example embodiments.

FIG. 19 shows an example of evaluation session and sub-sessions for relayed and resumable pre-owned electronic device evaluation, according to some example embodiments.

### DETAILED DESCRIPTION

Example embodiments will be described with reference to the accompanying drawings. It should be noted that the embodiments described below are illustrative, and are not intended to be limiting. Configurations other than those specifically described may be employed as appropriate according to some embodiments. Some example embodiments according to this disclosure provide for using a portable electronic device, without being attached to an associated fixed apparatus, to perform an entire evaluation of, or at least a part of the evaluation of, a POD.

The need to perform analysis of a POD for various reasons such as, but not limited to, trading, quoting, evaluation, protection plans or repair estimation, occurs often. Sometimes the evaluation systems described in applications mentioned above are not available to satisfy such needs due to space constraints of stores or due to reasons such as more and more transactions related to POD being made from home or another location away from a store or the like where an evaluation system described in the applications mentioned above is available. Sometimes the evaluation systems were not the best-suited due to the fact that many PODs have different sizes, such as, for example, from watch size to full laptop size. In some other instances, the cost of purchasing an evaluation system such as those described in the applications mentioned above may be seen as a barrier to its use. For these reasons, it became desirable to have smaller, more portable, evaluation devices still operable within the evaluation system ecosystem. The embodiments described in this disclosure provide systems and methods for substituting evaluation device in evaluation systems by transforming a portable device, such as a smartphone or tablet, into a portable evaluation device. By using software applications capable of providing at least some of the services required to evaluate a POD, such as the imaging of the device or automated machine to machine (M2M) testing of the audio and other components of the POD and combining new techniques to compensate for, circumvent, or render less significant, the benefits of having fixed structure and controllable environments.

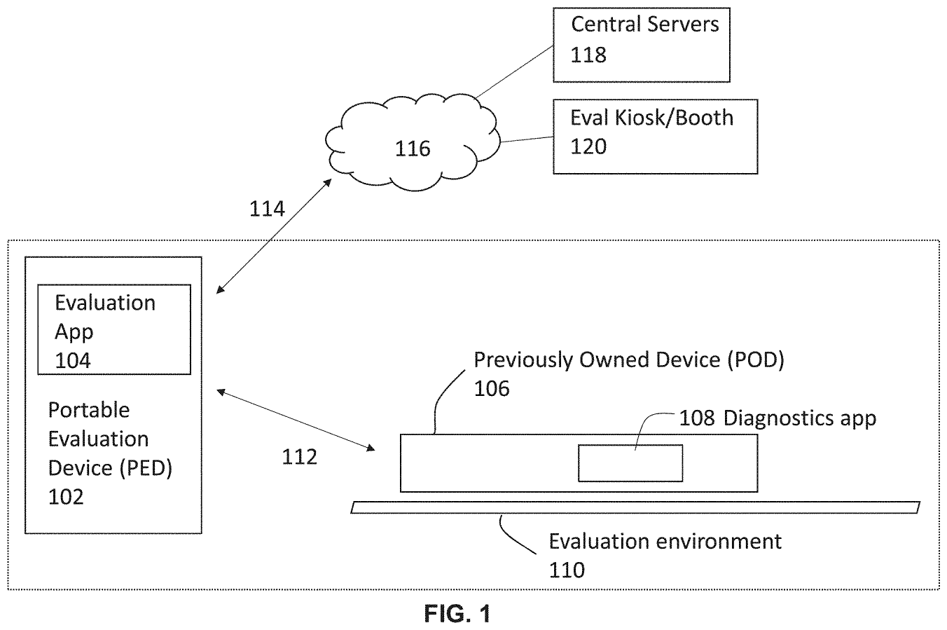

FIG. 1 illustrates an evaluation system 100 according to some example embodiments. A portable evaluation device (PED) 102 is used to perform either the entire evaluation of, or a part of the evaluation of, a previously-owned electronic device (POD) 106. The PED 102 may be a smartphone, tablet, or the like, and has an installed mobile application 104 for performing the evaluation or part thereof. The mobile application 104 may be stored in a non-transitory memory of the PED and/or may be obtained from a website, such as, for example, a website associated with a central server 118 and/or kiosk 120 providing evaluation services, or an application store such as Apple Store™ or Google Play™. The PED 102 may connect via a communication connection 114 to a network 116 which connects to the central server 118 and kiosk 120. The PED 102 may establish a communication connection 112, and in some cases may be paired with, the POD 106. The POD 106 may be installed with a diagnostic app 108 via the PED 102 or by another means. The evaluation app 104 may control or otherwise interact with the diagnostic app 108 over connection 112, or through a website, in order to perform diagnostics and/or evaluation of the POD 106. One or both of the evaluation app 104 and the diagnostic app 108 may be implemented, in some embodiments, as an App Clip™, in addition to or instead of being implemented as a web app, App Clips enable users to begin interacting with the application more quickly than downloading a complete web app would allow. App Clips may be allowed to access almost all if not all functions and system properties, such as cameras, in a similar way as web apps can do. App Clips are applications that are limited in size and are allowed to bypass some of the steps required to download, thus reducing the time from when a user elects to perform a certain task to enabling the user to perform the task. In some embodiments, a particular evaluation environment 110 (e.g. a white sheet of paper with or without unique markings, etc.) can be used in the diagnostics and/or evaluation. The PED 102 is not attached to a fixed infrastructure (e.g., such as a kiosk or booth) when performing the evaluation of the POD 106, and is moved manually in accordance with guidance provided by the evaluation app 104. In some embodiments, a part of the evaluation of the POD 106 is performed by the PED 102, and a remaining part of the evaluation process is performed by the central server and kiosk 120 utilizing the portion of the evaluation already completed by the PED 102. An evaluation process may, in some embodiments, include a diagnostics and evaluation of physical features and functions, and any of report generation, valuation, evaluation of trade-in options, evaluation of repair options, evaluation of other disposition options, etc.

Unlike the repurposed POD (rePOD) described in the '533 Application, which also uses a mobile application on a smartphone or tablet, the embodiments described herein pose a plurality of challenges to achieve this. In many RePOD evaluation systems described in the '533 Application, evaluation devices are attached, or are to be temporarily affixed, to some structure of an apparatus such as, for example, a kiosk, and the apparatus provides a standardized environment. The standardized environment, for example, provides an inspection chamber or inspection area, which may have a locking mechanism (access door) during inspection process or other such mechanism to prevent fraud by swapping devices, contain mirrors, have fixed or electronically controllable lighting sources to ensure POD in the inspection area are imaged in stable/controlled environment, and the distance between the camera and the POD is known for any captured images of the POD. These characteristics provide substantial advantages and efficiencies for many evaluations performed in the evaluation systems as they would allow for standardized imaging in the evaluation system. Such characteristics also allow for other standardization such as for example a known distance for testing audio components. The mirrors in the inspection area in some of the evaluation systems also allow a multiplicity of images to be extracted from one master image and provide a surrounding view of the POD.

As an overview, using a PED to accomplish equal or similar quality level evaluations as provided by fixed structures such as those described in the applications mentioned above, the following challenges may be required to be addressed in embodiments described in this disclosure:
Lack of a dedicated device, such as a single board computer, that is used to guide users in human tests and perform machine-to-machine testing;
Variation in evaluation device camera quality and resolution;
Variation and lack of control of the lighting environment;
Locking mechanism for restricting access during inspection (e.g., to prevent device swap during inspection);
Non-dynamic lighting environment;
Multiple image capture points are required due to non-availability of mirrors and use of a single camera (versus multiple camera in some embodiments); and
Adequate capture points in space are to be handled by untrained personnel, without fixed structure for guidance.

To overcome these challenges while providing equal or similar quality level of evaluation tests and evaluations performed by a portable evaluation device, several new methods are described in this disclosure.

### Device Pairing

To achieve device-to-device (e.g. between the POD and the evaluation device (e.g., PED)) interaction over a network of a plurality of devices where no unique identifier for one of the devices is originally known to the other device, a technique must be used to pair the devices in order to determine that a device instance, for example, an instance of PED 102 in FIG. 1, is in communication with a second device instance, for example, the POD 106. Such determination may be made by user input, as it is often seen in other areas of technology, for example, with Bluetooth device pairing. However, simple device pairing alone does not offer the security requirements to avoid device evaluation tampering, that is, pairing a wrong device for partial evaluation, and having visual inspections being made with a different device. A security challenge concept described in the '533 Application can be incorporated in some embodiments of this disclosure.

In some embodiments, a robust pairing technique may be quasi-automated and made more robust by making use of a unique identifier displayable or emittable (transmittable) by a first device, and having the identifier capturable by a second device so that the evaluation system, executing either on one or the devices or as a remote service, may pair the devices together which allows for further device to device communication, or device to server to device communication Similar to the security challenges described in the '533 Application, the PED is more subject to fraud because of the lack of a controlled and/or locked environment where no human manipulation can occur between tests. For example, with a PED, it is possible for a person to “change the phone” when taking the back surface picture of the POD, thereby showing the back of a different device that could be in good condition, while the POD under analysis has a damaged back surface. This is more important in certain situations such as when, especially in light of the newer smartphones, the POD having glass as a material for the back, which is costly to repair.

To circumvent this, a plurality of security challenges may be applied. For instance, when a PED is taking images of the top of the POD, a first QR code security challenge may be made, which, in more detail, may be performed for example using the following process:
The evaluation system sends a first computer recognizable identifier, for example, a QR code, to be displayed on the POD;
The PED takes a first picture with the first computer recognizable identifier displayed on the POD, the captured displayed first recognizable identifier is evaluated against the first computer recognizable identifier transmitted to the POD (while also permitting automatic device pairing);
The evaluation system sends a second computer recognizable identifier, for example, a second QR code, to be displayed on the POD;
The PED takes a second picture with the second computer recognizable identifier displayed on the POD, and evaluates the captured displayed second computer recognizable identifier against the second computer recognizable identifier transmitted to the POD, thereby preventing device swapping, or taking a screenshot from a first device and then displaying it on a secondary device:
   This enables a dynamic security challenge to validate at least two control points and thereby reduce fraud opportunities for fraudulently substituting devices. For example, if the first scan by the PED of the QR that is displayed on the POD is a trigger to now send a new, “live” QR code while the PED is still hovering over the POD, there time window to swap will be minimized or eliminated. Dynamic security challenge may be implemented in a variety of way: two or more recognizable identifiers (such as QR code), dynamic video similar to the Apple to Apple new device pairing process, combination of other recognizable identifiers for example a sound signal, a LED flash signal, a notification message being sent to the device (which would cause the notification to be displayed), etc.
Optionally, to prevent “screen sharing” type of risk (where the POD displays to the display of another device via screen sharing), the computer recognizable identifier (e.g., QR code) can be required to be rendered with a hashing mechanism, for example, with the help of the MAC address of the device on which the computer recognizable identifier is rendered, which is transmitted separately to the evaluation system, and allow the evaluation system to ensure the computer recognizable identifier was displayed on the device having the proper MAC address. The following scenario presents one technique the can be used to prevent screen sharing fraud:
   In an example scenario, a user may have 2 similar devices and one has a bad cosmetic condition while the second is in good cosmetic condition.
   A malicious user can try to use screen sharing so that the evaluation system thinks it sees a good condition device while in fact it is operably connected to, and has retrieved IMEI and other device information from, a bad condition device. The user may then attempt to claim that the damage occurred later, e.g., during transportation.
   Example embodiments may circumvent the occurrence of such fraud. Example embodiments implement a way for the evaluation system to send information such as an encryption or hash key or any complement to such key, specifically and only to the device that is in-sight of the PED. Because we are trying to prevent from screen sharing, we cannot take for granted that the device in-sight is the device we're in communication with.
   To ensure the authenticity of the device in sight is actually also being digitally connected to the evaluation system, for example that it is not a screen-shared view of another device, the application software running on the POD could, at some point, be required to operate a reverse security challenge in which it would recognize an information, for example through a light series or through a visually displayed recognizer for example a QR code displayed on the PED and presented to the POD in such way that, the information may be a key or a complement to a key used within the security challenge. An exemplary embodiment of such complete bidirectional security challenge pairing could be implemented this way
Additional computer recognizable identifiers may be sent, for example, for every screenshot taken of the POD by the PED, ensuring device authenticity; and
Especially for the picture of the back of the POD, alternative computer recognizable identifiers may be used for the security challenge, for example a pre-determined sequence of light on, light off, with predetermined durations could be activated using a POD back LED light, much like Morse encoding, which could allow an evaluation system to authenticate that the back picture was taken with the proper POD. For example, the evaluation system may expect the following light sequence, probably operated at a very low bitrate such as for example at 10 bits per seconds, which bitrate should be at least below half the camera frame rate in order to allow for the adequate image sampling and computer vision from the portable evaluation device camera: 11000101010101001101 fora 20 bit code in 2 seconds at 10 bits per seconds (1 represent activating the light, 0 turning off the light).

An example scenario associated with attempted fraud using “screen sharing” is described. A malicious user may have two similar devices where one has a bad cosmetic condition while the second is in good cosmetic condition. The malicious user can try to use screen sharing to trick the evaluation system thinks it sees a good condition device while in fact it is operably connected to, and has retrieved IMEI and other device information from, a bad condition device. The user may thus attempt to conceal the true condition of the device, and then subsequently if necessary may attempt to claim that the damage occurred during transportation.

Example embodiments may circumvent the occurrence of such fraud. Example embodiments provide for the evaluation system to send information such as an encryption or hash key or any complement to such key, specifically and only to the device actually in-sight of the evaluation device. Note that, in order to prevent screen sharing for the above fraudulent purpose, the evaluation system cannot take for granted that the device in-sight is the device it is in communication with. Techniques such as, for example, using the flash LED of the PED to send a Morse-like code (such as, for example, described above for taking back picture) to the device that is in sight, or, flipping the PED over so that the camera of the POD captures an information displayed on the PED (e.g., a QR code or another computer recognizable identifier).

To ensure the authenticity of the device in sight is actually also being digitally connected to the evaluation system, for example, that it is not a screen-shared view of another device, the application software running on the POD could, at some point, be required to operate a reverse security challenge in which it would recognize an information, for example, through a light series or through a visually displayed recognizer for example a QR code displayed on the PED and presented to the POD in such way that, the information may be a key or a complement to a key used within the security challenge. An exemplary embodiment of such complete bidirectional security challenge pairing could be implemented the described manner.

These techniques may also be used to offer multi-layer challenges for more robust pairing authentication, such as, for example, requiring a sequence of two computer recognizable identifiers (e.g., QR codes) to be recognized.

Use of these pairing techniques may be performed on the application based diagnostics and/or web-based diagnostic models.

### Lack of Dedicated Device

To circumvent many of the problems caused by the lack of a dedicated evaluation device, embodiments of this disclosure may use any of three techniques, or a combination thereof, to provide similar evaluation levels as provided by systems with dedicated evaluation devices. In order to do so, the PED, which may, for example, be a smartphone or a tablet, uses a mobile application (referred to as “evaluation app” or “home app”) that mimics several of the functions provided by dedicated evaluation devices.

The first technique makes use of a diagnostic application or services in an application, the second technique makes use of a web-based diagnostic, and the third technique uses basic display of a page presenting a POD IMEI.

In an embodiment that uses a diagnostic application or services in an application, a smartphone application, similar to applications described for a rePOD as described in the '533 Application, acts as a ‘“virtual” evaluation device, but in order to work appropriately to overcome the challenges identified above, may contain several of the techniques described herein.

The evaluation may be implemented as a standalone application, or, in some embodiments, the functions embedded in another application, such as the mobile application, may be embedded in the same diagnostic application that may be used to diagnose a POD. In order to do so, some embodiments are organized so that the mobile application software may be used interchangeably as the POD diagnostic software, or as the PED software (e.g. the evaluation app referred to above), by selecting an operation mode.

When operating in diagnostic mode, the application software would:
Guide users to perform the tests necessitating human intervention, for example touching all, or selected, areas of the screen; and
Provide to the evaluation system (server or evaluation devices) the services, through service interfaces, needed for the evaluation device to perform its evaluation, for example, changing the screen color to “red” after receiving such instruction from the evaluation system, allowing the evaluation device and the application software to capture and evaluate or transfer for evaluation the captured red image of the screen, and the like.

When operating in device evaluation mode, the mobile application would act as an evaluation system component, and provide many or all of the services typically provided by evaluation apparatus, combined with the techniques described herein to overcome the identified challenges.

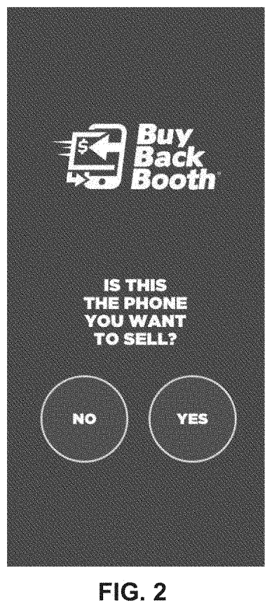

To determine the operating mode of the PED software, several techniques may be embodied. In an exemplary embodiment, a user interface allows for the mode selection to be determined, for example, by providing ‘mode’ selection buttons, or an interface question permitting the determination of such mode. For example, in an embodiment, the following question may be asked (FIG. 2): “Is this the phone you want to sell? Yes No”. Users selecting “yes” indirectly indicate that the software must operate in diagnostic mode, while users indicating “no” would set the operating mode to evaluation mode.

In another embodiment, a URL parameter is used to preselect an operation mode. In such embodiment, the URL parameter may be set for example as: appurl://operationmode=diagnose. In another embodiment, multiple GET URL parameters could be used to preselect an operation mode alongside other information.

In such embodiments, the URL parameter may be embedded for example in a QR code, allowing a user to scan a QR code from a camera of the POD that is to be evaluated which may then trigger the POD operating system to open the relevant store for downloading and installing the application, or opening the application if it was already present. For instance, the QR code would be an encoded link to a website that would redirect the user to the appropriate step depending on if the POD already as the diagnostic app installed then the app url to open it is prompted, if not, the app store will be opened for the user to install it.

In such embodiments using a QR code, the URL may be printed on a surface, or on a marketing material. In other embodiments, the QR code is displayed for instance using a web page, a kiosk display, a POS display, or another application. For example, the QR code may be made available on a smartphone carrier website under a ‘trade-in’ your phone section, which, when scanned by the existing smartphone of a user, would become a starting point for the trade-in process. Other processes, such as gathering a certification report, repair estimations and etc. (see concurrently filed U.S. Provisional Application 63/106,635, the entire content of which is hereby incorporated by reference) may also start using this technique.

In such embodiments using a QR code displayed on a screen, because the identifier can be generated each time (for each ‘session’), an identifier corresponding to a session with the user may be added to the URL, for example randomly or sequentially generated, which may be used for activity traceability purposes, and to facilitate the user experience, as it will be further described herein. As an example, the QR code may generate a link with a campaign id for the POD to go to and download the app. Once downloaded, the POD would be trackable using some fingerprinting method to match said installation with an associated campaign id.

It is important to note that embedding both functionalities (i.e. diagnostic functions and evaluation device functions) into a same app may be a desirable feature in some instances, but the same functionality may be achieved in some embodiments by having two different applications, the first application providing the diagnostic functions and services, and the second application providing the evaluation device functions and services. Alternatively, other embodiments of the present disclosure provide the services as integratable packages for third party mobile application designers or publishers.

Embodiments providing integratable packages may use any technology to support integration, such as source code, services (e.g., webservices or other services accessible through services interfaces), libraries, API or SDK to achieve the results described herein. Exemplary embodiments of applications integrating functions may be, for example, a smartphone carrier already providing its users with an application for example for account management purposes, but also desire to integrate either the diagnostic functionalities, or the evaluation functionalities, or both. For example, it may be desirable that, a user ordering a new smartphone, either online or at a store, has the portable evaluation device application functionalities pre-loaded, either as a standalone application, or embedded in the carrier application. Therefore, when referring to the mobile application, whether the diagnostic application or the evaluation application, the description herein refers to the services offered by an application, which may be a standalone, a dual function application, or partially integrated into another application that offers a plurality of services.

A problem solved by some embodiments is that many persons that may desire to trade their smartphone, prefer to ensure that their new smartphone has all the data transferred to it and is running properly for a few days before proceeding with trade-ins. By having the portable evaluation device functions readily available, either as a standalone application or embedded within their own application, the carrier may facilitate the process, for example, by allowing the trade-in process to be partially or totally completed at home, even several days after purchasing of a new device, in store or online.

In such embodiments where the PED functions are already present on a new device, different starting points may be offered. In one of such embodiment, the evaluation device functions may be used to initiate the process which may include presenting on the new smartphone a QR code for the POD to capture and, by using a fixed QR code, or generating a unique QR code (for example with embedded unique identifier) and using the embedded URL techniques described above, continue with the process.

An alternate embodiment that provides a session ID to the evaluation system may be performed by having one of the device camera pointing at the display of the other device, and having the first device read a unique identifier (e.g. a recognizable identifier as referred to above) displayed on the display of the second device, which permits, for devices connected through a network, the establishment of a communication channel between the two devices for them to interact, directly or with the use of intermediary services, such as a server in communication with the two device.

Embodiments of this disclosure using integratable packages may be operable so that third party applications may communicate information to a common diagnostic application and/or a common evaluation application. By transmitting the information from a third party application, an improved user experience may be achieved. For instance, a first application is a third party application and has been published by a cellular carrier company. The first application may provide several features and benefits outside the scope of the disclosure, however, such applications may also integrate with either:
The diagnostic application, which may be helpful for warranty or repair services;
The evaluation application, which may be helpful for example to complete a device trade-in process of another POD; or
Both.

While integrated results may be achieved by other integration methods specified (SDK/API), an alternative method is to pass information from a first application, which may be any of an identifier relatable to the cellular carrier company, or a reverse logistic processing company associated with, a session identifier, an IMEI, etc. Using the information received from the originating third party application, the diagnostic application or evaluation application may, accordingly, adapt or facilitate the experience.

Some embodiments using integration methods may provide or enable additional features, or use specific datasets to tailor a user experience. For example, when using an integration method, diagnostic or evaluation applications may be able to assess pre-evaluation probable trade-in value because they can associate an evaluation session with a specific carrier, which uses a specific reverse logistic company. By associating a session with a specific dataset, it is possible to provide probable pre-evaluation pricing for a device.

### Variation in Evaluation Device Quality and Resolution

Each model of smartphones and tablets have different cameras, focus lenses or camera firmware or software that may result in significant differences in the picture quality. The same picture taken by two different models of a smartphone, even at the same exact position in space and with the exact same lighting environment may result in significantly different images. These differences may become important as they could result in defect analysis mechanisms behaving differently, when such mechanisms are made by trained human operators, trained artificial intelligence systems or programmatic functions, and may be the source of false positives or false negatives defects.

Some embodiments of the evaluation system may be configured to first determine the quality level of the camera of the portable evaluation device. It may do so by applying different techniques, for instance, it may first recognize the portable evaluation device make and model (i.e. iPhone 7) and access a database to retrieve information pertaining to this specific model. It may determine from this information if the camera system is acceptable, not acceptable, if some proactive actions, such as, for example, specifying some camera settings before taking images, or if some corrective actions must be taken before processing images. Alternatively, some embodiments may inquire directly or through the operating system services about features of the camera, such as, supported resolution, frame rate, etc.

Some embodiments of the evaluation system may also use image analysis or computer vision techniques to determine the viability of the images taken by the portable evaluation device. For example, by using color histograms, image histograms of a known image, or on a subset of a known image, it may be able to determine characteristics for accepting or rejecting the portable evaluation device, or applying proactive or corrective actions. For instance, an embodiment of the evaluation system in communication with a POD and a portable evaluation device, may demand the POD to display a known image or pattern, take an image of the POD using the evaluation device (after guiding the user accordingly to embodiments described herein), and, based on the analysis of the image, determine that is has sufficient brightness, contrast, is in focus, etc.

### Variation and Lack of Control of the Lighting Environment

Some embodiments provide means to guide the user in correcting the ambiance lighting environment to circumvent at least some of the lighting-related problems identified above. For example, using histogram analysis, a PED looking at a known displayed image on the POD may determine that the ambient lighting level is inadequate, or that the ambient lighting set is inadequate because it provides too much of a given base color (RGB). By analyzing the color histogram on complete or subsets of the image the evaluation system is able to determine whether the lighting is adequate or not. For enhanced clarity when using this method, an embodiment of this disclosure may demand a user to place a POD on a white paper, and, taking a first picture using the PED conveniently placed at the top of the POD, ensuring the image covers a substantial amount of the available pixels. The evaluation system becomes capable, for example using computer vision techniques comparing a first image with a black background displayed on the POD and a second image with a white background displayed on the POD, to determine surface coverage. The evaluation system, continuing on with analyzing these images, is capable to determine adequacy of the lighting environment by analyzing tonal distribution, by applying color histogram, and/or image histogram techniques to the various images and/or a subset, for example the subset corresponding to the display area where the two images substantially differ. Some embodiments may use the surrounding area of the POD images as reference points for which the color may be known, for example that may be presumably white when instructions to use indicates the user to use a white sheet, or any color such as green when a processor or carrier provided the user with a printable template or a pre-printed background sheet. QR codes may also be used as reference points to help in the determination or adjustment of the ambient lighting, white balancing, brightness, contrast, colors, etc.

For the evaluation system to determine adequacy of the lighting environment, it may compare the various histograms created with color or image histogram techniques with acceptable threshold, determining that the brightness, the contrast, and capable of doing so for each of the base color (RGB) provide for an acceptable ambient lighting. Images taken in an acceptable lighting can be flagged for further analysis, for example, submitted for defect analysis. Images taken in unacceptable lighting can be refused, requesting the user to adjust the lighting accordingly or possibly, for some lighting defect that can easily be corrected, processed through filters and image enhancement algorithms before being submitted for analysis.

### Non-Dynamic Lighting Environment

To achieve high quality defect analysis, especially on glass surface, previous applications of the applicant, such as those mentioned above, described a technique known as DLST (Dynamic Lighting Source Technique) wherein a plurality of light sources may be controlled by the evaluation system, creating different lighting environment and causing light to be reflected on possible broken areas of the glass, therefore enhancing the probability of detection.

To maintain the advantages of such capabilities, the inventors developed a variation of the DLST that the inventors named MLST (mobile lighting source technique). The MLST uses, when available, at least one of the PED “flash” function (LED light placed nearby the back camera) or the POD device “flash” function, and taking, when appropriate, images with and without the light flash on. For example, an embodiment may require the user to take pictures at 6 different positions, each outlying (focusing) on the main structural side of the POD: top, bottom, up, down, right, left. Using the MLST, the PED may take a first image of the POD top face with its flash off, a second image of the top with its flash on, a third image of the right side with flash on, and so on, up to 12 distinct images, two for each surface. The evaluation system may combine more images, for example, by displaying colored surface, images or patterns on the POD display. By taking plurality of images using this technique that simulates different lighting environment, the evaluation system is capable of substantially improving the probability of detecting defects even in an uncontrolled environment.

### Multiple Image Capture Points

As described, many embodiments will require the user to position the devices at various points in space and at various angles, so that adequate pictures can be taken from all sides of the POD. In some embodiments, capturing images of less than all the sides of the POD may be sufficient for the evaluation.

A first technique to achieve capturing images from multiple capture points is to instruct the user to place the phone at an approximate angle and distance, so that the camera can capture, for example, the right side of the POD, then instruct user to move either device (POD or the PED) so the camera of the PED can now capture for example the left side of the POD, and so on. This technique is likely to lead to a high variance in the images taken by the evaluation device in terms of focal distance, focus, angle, position.

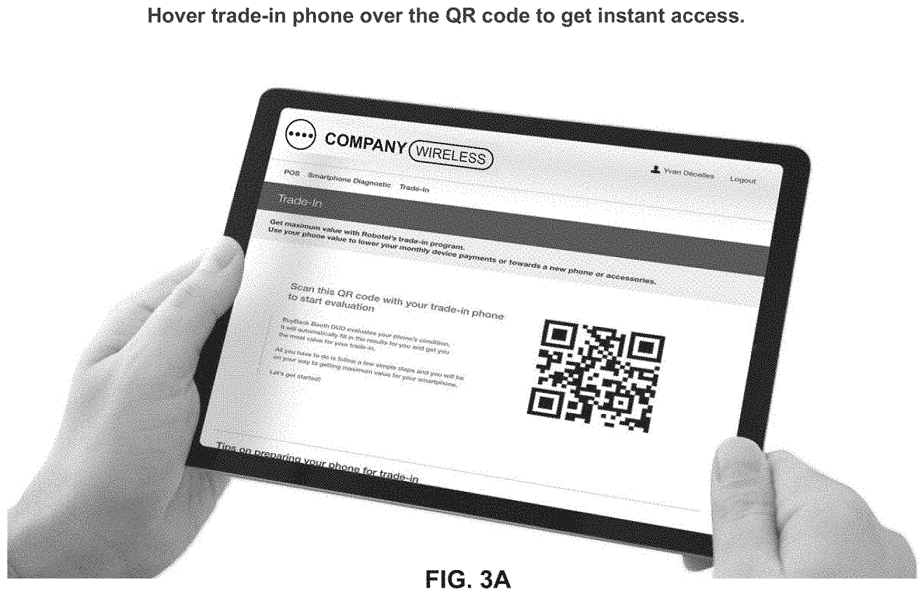

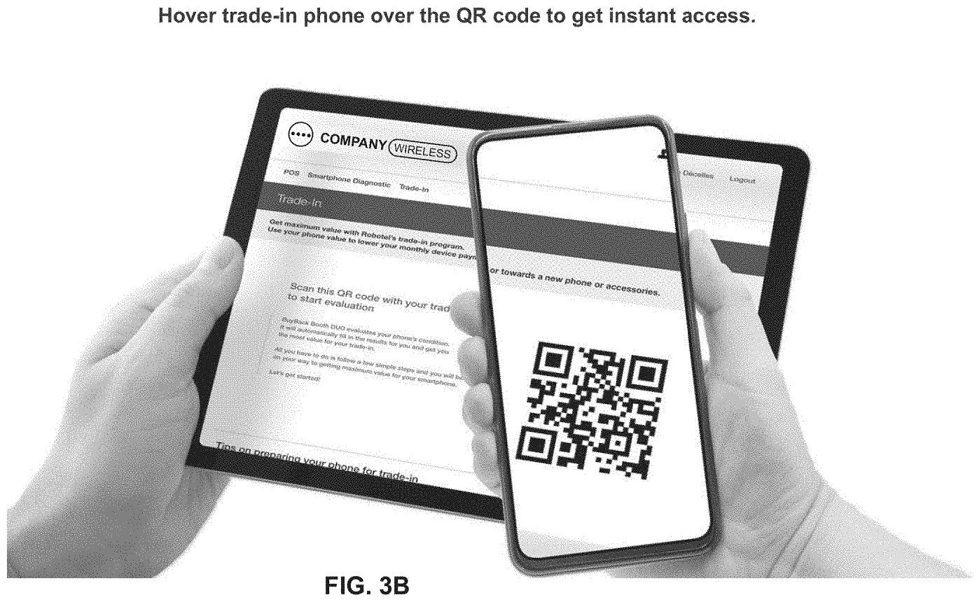

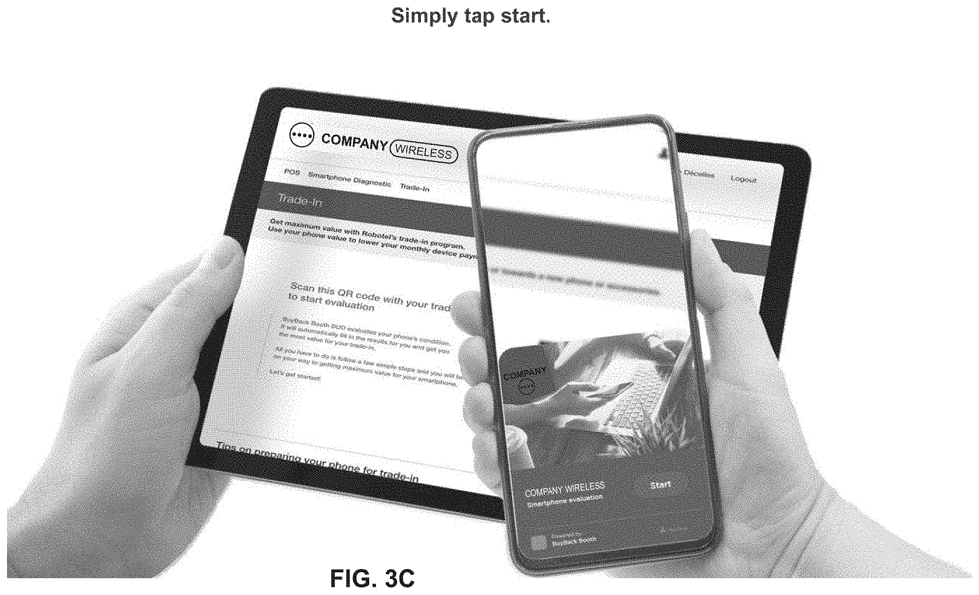

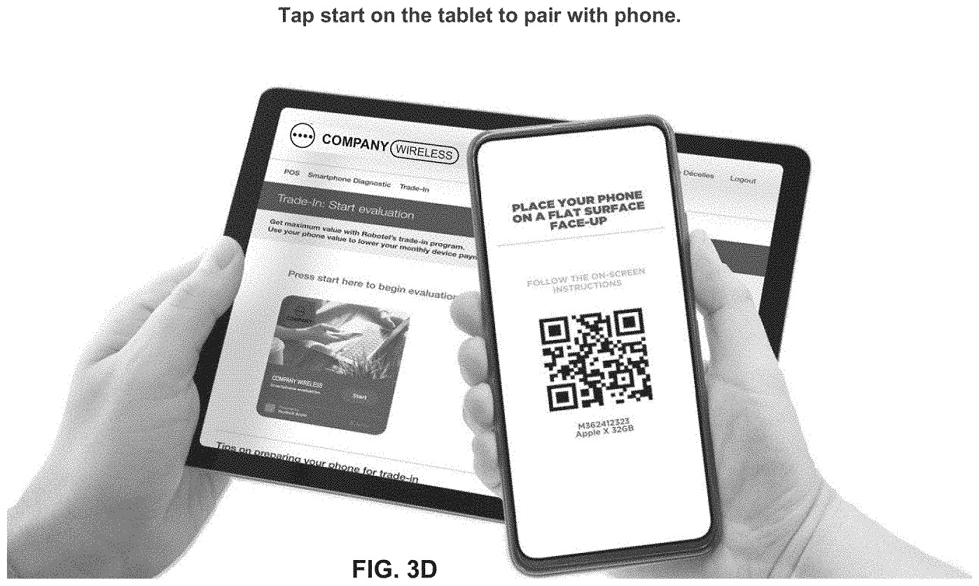

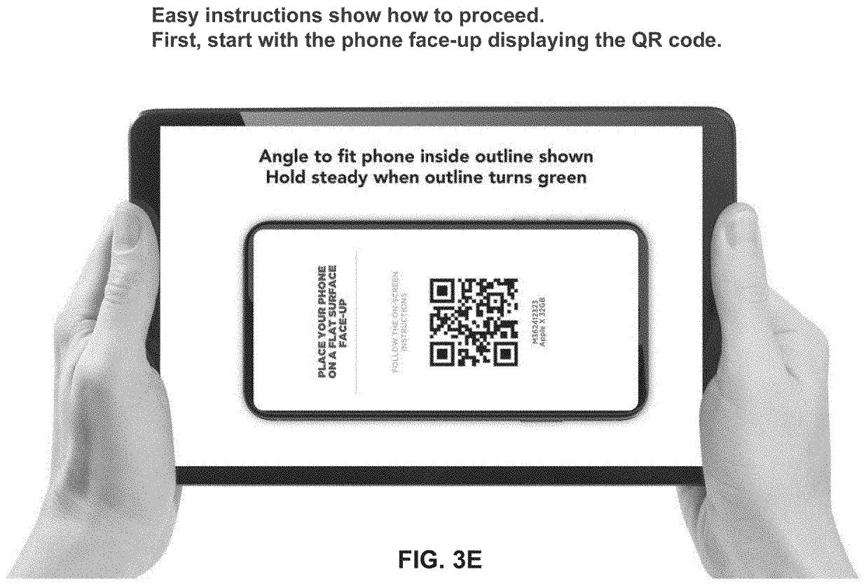

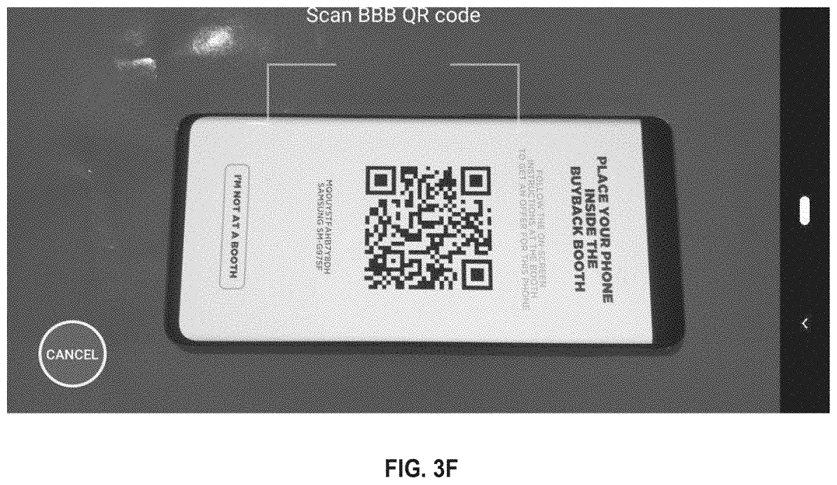

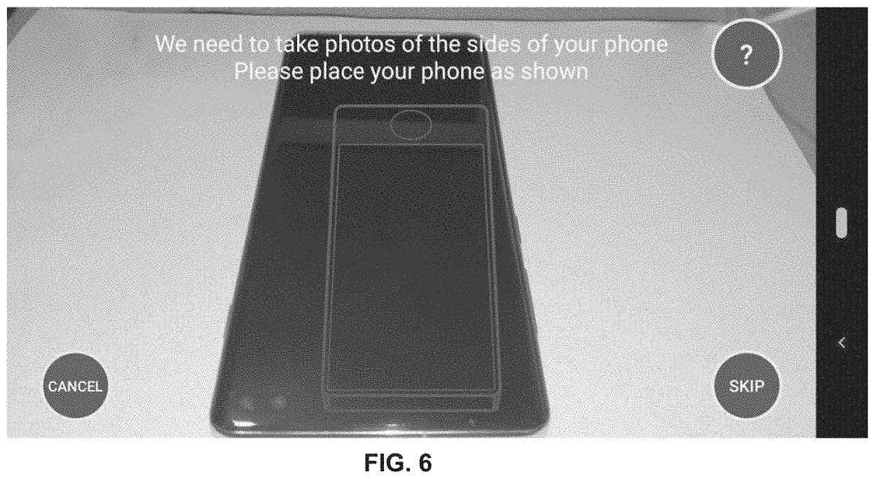

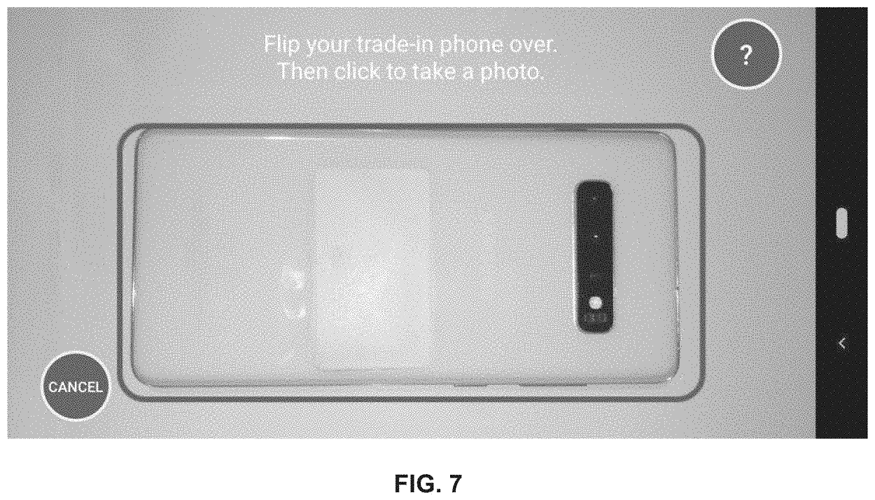

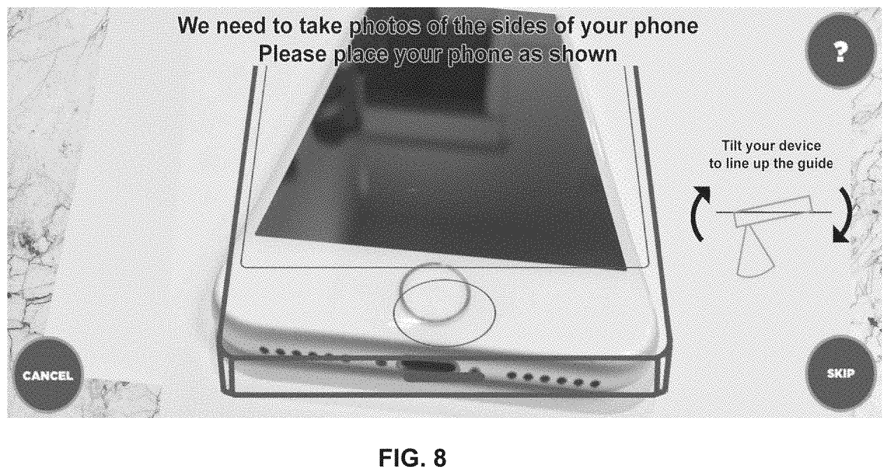

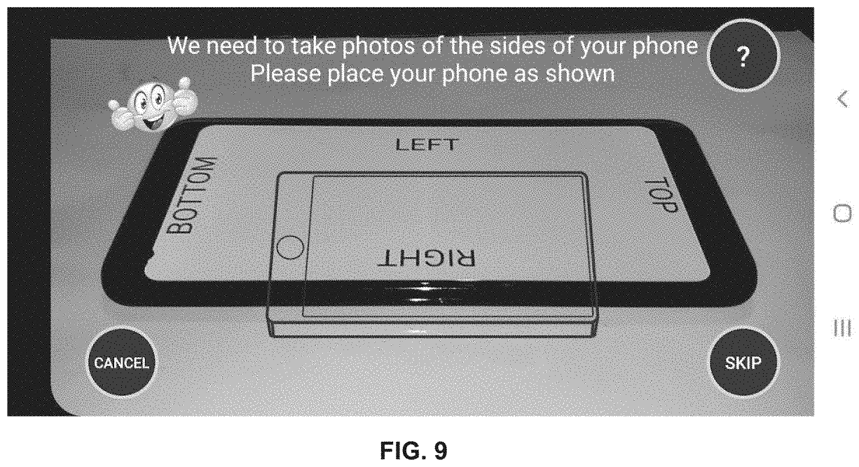

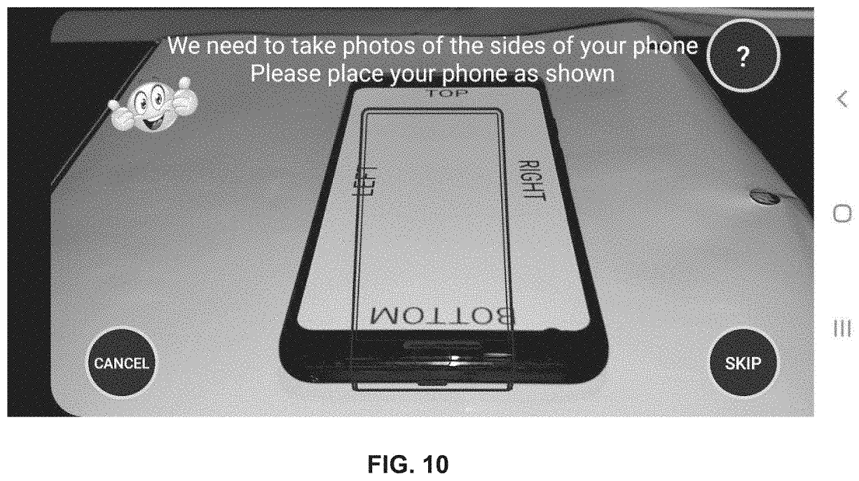

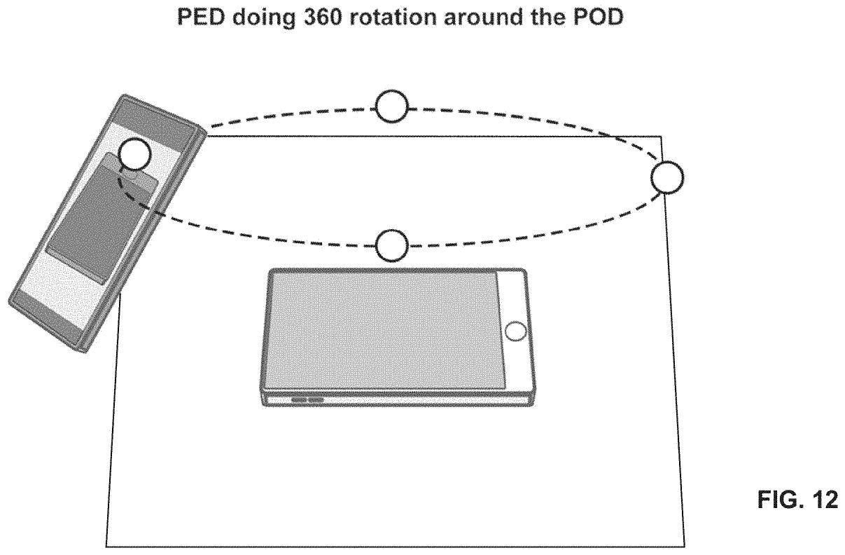

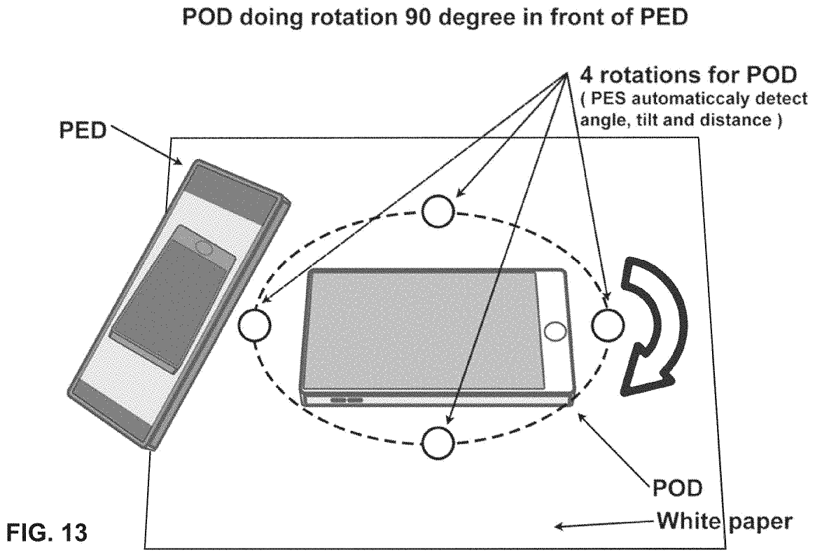

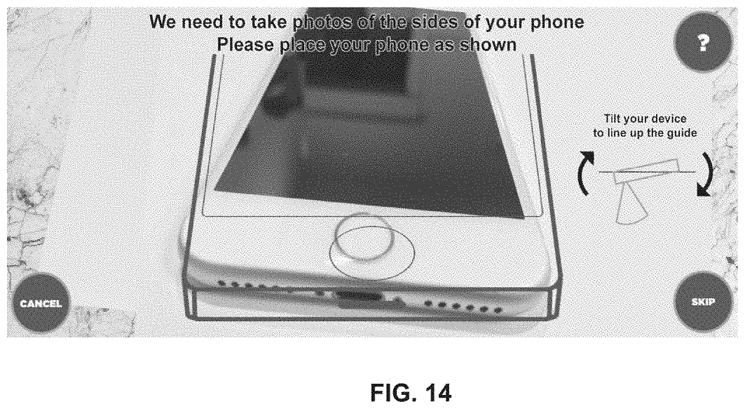

Some embodiments improve this base technique by applying camera preview overlays on the display of the PED (FIGS. 3-7, and also FIGS. 8-14 showing 3D overlays with augmented reality). The overlays will significantly help the user operating the PED, by moving either of the devices, in order to achieve an adequate angle and distance, by instructing that the resulting image should, more or less, cover the one (or area on the other device) indicated by the template. For example, an embodiment may require that approximately 90% of surface indicated by the overlay (or a subset of) be covered by the device (POD) before accepting the image, understanding that the overlay or its subset corresponds to the region of interest, for example, a top picture (image of the top surface of the POD) has a large region of interest which correspond to the entire device, but a picture of the left side will limit to a subset of the overlay, which may be a rectangle of half the overlay surface, the area to analyze for determination of the validity of the image, understanding that the same concept (region of interest) may be applied to other triggers, such as determination of what area is in focus or has sufficient lighting.

Some embodiments further improve this base technique by using 3D positioning, which may use artificial intelligence and augmented reality techniques, including, but not limited to, computer vision, object detection, optical character recognition, QR, barcode or other identification scanning and recognition, etc. These techniques may be either embedded or programmed in the POD or the portable evaluation device, may rely on online third party services frameworks such as Firebase™ from Google, or other services that could be provided for instance using service interfaces to servers of the evaluation system.

Some embodiments may enhance 3D positioning techniques, by using when available on the POD and/or on the PED, motion or position sensors such as, for example, gyroscopes (angular rate/velocity sensors), accelerometers, etc., in order to determine the relative and/or absolute positions of the POD and of the PED and/or angular positioning.

Some embodiments may use different image processing techniques that analyze the quality of static images or image streams (such as camera preview streams) as a whole and also at pixel or groups of pixel level, such as color histogram analysis, primary colors pixels levels analysis, edge detection filters, for ensuring that at least one image is taken with a proper (e.g. a predetermined and/or preconfigured) focus, brightness and/or contrast. These techniques can be static (e.g., one image analysis) or dynamic (e.g., using an image stream) requiring the user to move or rotate either device so that the selected measurement variables indicate measurements within desired thresholds as determined by one or more preconfigured thresholds.

Some embodiments using 3D positioning techniques may display either on the POD or the PED, or both, positioning and/or general instructions, which may be any combination of dynamic or static text, pictograms and images indicating the user to move or displace either device so that the camera points at the desired evaluation surface, at a certain approximate angle and distance. Indications may also ask for more generic instructions such as requesting a brighter environment or the like. The instructions to the user, such as “move closer”, “move farther”, “bend toward”, etc., alongside probable histograms will help greatly in reducing the approximation of the images taken. FIGS. 8-14 shows an interface for guiding the user.

To achieve distance evaluation either from imaging only, or combined with 3D sensors, a reference distance, which may be measured by knowing or identifying properties from a reference object may be used. The object reference may be the POD itself, since its physical dimensions may be extracted from a database, for example, using the POD make and model. In some embodiments, the distance (depth) can also be determined using more than one image of the POD, for example, by taking images before and after the POD is moved a short distance (e.g., 2-5 inches). This technique may be used in conjunction with existing frameworks, or enhanced LIDAR or multiple cameras of some more recent smartphones that can be used as PED.

Therefore, in order to achieve this augmented reality interface, some embodiments may combine, or alternatively use computer vision techniques for properly positioning (e.g., placing in space and at desired angle) the POD or the portable evaluation device. For instance, by using object identifications and other computer vision techniques, such as, for example, OpenCV™, the object detection with TensorFlow™, etc., a PED may be capable to adequately evaluate the angle and distance to the POD, for example, by identifying a reference point or object, such as the make and model of the POD as reported by the diagnostic software on the POD, or a known QR code size, and, using common computer vision techniques, the evaluation system or evaluation device becomes capable of adequately ensuring a distance is respected and provides similar feedback and is capable of providing feedback instructions as if it was using 3D sensors. Embodiments may combine such techniques with other computer vision and OCR methods that could indicate the orientation of the POD, for example, using MLKit™ or similar software.

### Web-Based Diagnostic Methods

In some instances, downloading and installing a mobile application on a pre-owned electronic device may be cumbersome. While the best diagnostic results may be achieved by using application software because they inherently have access to more system call functions than is possible using web technologies, many of the diagnostics and evaluation methods described previously (e.g., in the '533 Application and other applications mentioned above) or herein may also be implemented using web technologies. This implementation may be used for instances where a full, thorough diagnosis is not required, or for instances where a pre-evaluation of the device is deemed significant, which may require a final diagnostic to be completed using the diagnostic application before completing the evaluation.

Some embodiments of this disclosure provide one or more of a plurality of tests that may be performed using a portable evaluation device application, which may be for instance installed on a store sales representative mobile phone or tablet, or pre-loaded on a smartphone or tablet, purchased in store or online, and, instead of using a mobile diagnostic application on the POD, the POD is directed to a diagnostic web-page that can interact with the portable evaluation device as described herein. The web diagnosis services may be used as substitute to several of the services described herein for diagnosing, evaluating or testing the pre-owned electronic device. In such instances, the evaluation system, instead of rendering the services using mobile application software and techniques, renders the same or similar services using web technologies.

### Web Pairing

The web diagnosis services needs first to pair the POD with a PED, using the techniques previously described or herein described. For instance, a unique QR code may be displayed through the web page rendered on the POD, and the portable evaluation device may be configured to react to the information contained in the QR code which is, or contains, a unique identifier, and, by submitting the unique code to a service in relation with the creation or rendering of the QR code, may pair the devices, rendering possible either device to device communication, or using intermediary services, device to server, server to device communications.

Some embodiments using web diagnosis services will use a pairing technique so that the portable evaluation device becomes operatively in communication with the POD, either directly or using intermediary services or servers.

In some embodiments using web diagnosis services, the following services also offered by the diagnosis application may be rendered using web technologies: display identifiers, display colors, display pattern, display image, touch areas, automated speaker and microphone tests (one of the POD or evaluation device can play a sound, for example an audio sweep, to be recorded or analyzed by the other device, and vice-versa, Bluetooth, GPS, cameras, etc.

### Traceability

Traceability is generally known as the ability for a system, such as, for example, a website, to trace users moving in one or more websites (e.g. such as “web tracking”). This helps keeping track of user visits, and providing for resuming visits, etc. An issue faced in environments described in this disclosure is that the user experience is not necessarily occurring only within a given web browser, but can span multiple devices and environments. For example, a user, say user 1, is on the verizon.com website and is looking for a new iPhone valued at $500. When ready to check the trade-in value through the evaluation application described in this disclosure, the evaluation system may want to know (trace) it was user 1 on verizon.com. User 1 will begin running the diagnostic application on the POD, then, when the PED is evaluating the POD, it ideally needs to know, directly or indirectly (not necessarily the PED, but the evaluation system) that it is indeed user 1 that is with (associated with, or owning) the POD. By tracing the user activity, the originating website may then be updated, in realtime or quasi-realtime, so that the valuation of the POD as completed by the two smartphones (the POD and the PED) is for example $100. The website may then use that information to apply a “trade-in value” showing the user that the upgrade, minus the $100, will be only $400 (and not the full price of $500). Traceability methods permit this type of operation. Example embodiments, provide efficient techniques for multi-device traceability in the context of trade-in etc., of pre-owned devices.

Some embodiments may utilize tracing capabilities from a website. In some embodiments, using identifiers for traceability of sessions, once an evaluation is completed the user may be sent back to a URL containing information relating to the session, which may be using the session ID as a URL GET parameter, or, using realtime web methods, such as long polling, SSE (Server Sent Events), Websockets or other real time frameworks. Using real time methods allow the originating web session to get automatically updated with information from the evaluation session, either in real time, or at the end of the evaluation. An example of such embodiment may correspond to the following use-case:
A user navigates to a carrier store website or other relevant website (e.g., verizon.com) offering trade-in, or advertising trade-in services;
The website, for example a carrier website, may propose one or more trade-in options or disposition options and, to integrate with the services described herein, create or requests through a service interface the creation of a QR code or URL, and render the QR code or URL available on its website (e.g., on a webpage displayed to the user);
The created or requested URL contains an identifier embedded or parameterized in a URL and optionally a campaign ID which may be rendered as a QR code;
The user scans the QR code with the user's POD, which causes the operating functions of the POD to open the URL embedded in the QR code;
The URL is served by a web server or service which upon receiving the http requests, determines the proper online store for the requesting device, for instance Apple or Google, based, for instance, on browser information, and redirects the user to the proper online store for downloading the application;
Alternatively, if a web-based evaluation method is offered, the web server or service may redirect to substitution web-diagnosis services;
During the evaluation, the evaluation system may use a real-time method to populate information or update the information on the originating web session;
After the evaluation system completes the evaluation, the user may be sent to the originating website, or a new URL allow the user to be redirected to resume the session with probable information, for instance a price or a plurality of disposition options, or real-time methods may be used to indicate the evaluation is complete, and may include information about the evaluation, including the price or possible disposition options; and
The web server may resume with the additional information received based on the evaluation of the POD, for instance apply a “trade-in” cash-down equivalent.

In some embodiments an evaluation or a pre-evaluation may be performed in-store, using, for example, a mobile device such as the smartphone or tablet of a sales representative as the PED. The diagnostic application may be downloaded, for instance, by downloading from the appropriate store, or conveniently routed using a QR code URL that conveniently redirects accordingly, as described herein. Alternatively, a web diagnosis can be used.

In some embodiments traceability is made by associating an evaluation session, which may be represented by the id of the evaluation (e.g., such as stored in a JSON file), with an electronic message address associated with the owner of the POD, such as a phone number, electronic email address or an address on some other electronic notification capable service.

An example use-case may be:
A user desires to purchase a new smartphone in a retail store and has a POD which in this use case is a smartphone;
A trade-in option is offered to reduce the acquisition price;
The PED in this use case is a tablet or smartphone used by store staff and displays a unique QR code containing a traceability identifier embedded or parameterized in the QR code, such as, for example, in a URL;
Another identifier may be demanded, optionally, for instance, the phone number or other electronic address;
The POD scans the QR code displayed on the PED;
A web diagnosis method may be preferred because it provides a simple way to pre-evaluate, the promise to purchase may be pending the full use of the diagnostic application, for example, at a later time, which may allow for a user to complete disposition after the new device (in this case, the new smartphone) is deemed functional, and all data have been successfully transferred;
The evaluation or pre-evaluation is performed using mobile application or web diagnosis services;
A plurality of options may be offered which are based on the evaluation of the POD, for example, a promise to purchase “here, now”, multiple disposition options, offering a protection plan for the POD, estimating repair material, estimating repair costs, providing certification report of the POD, etc.; and
At a later time, a notification service may be used for instance to remind the user of at least one of the plurality of options, for instance, a text or email may be sent, or a push-notification may be sent to the owner of the new device (such as the new smartphone), which is rendered possible because of the traceability options described herein, in this case, associating the new device or the application instance with the user.

By providing a complete function and visual evaluation framework using a PED as described herein, most services offered by evaluation systems using dedicated apparatus may be rendered, or improved, using the PED at least as an entry point to the evaluation system. Certain embodiments according to this disclosure enables performing a highly accurate evaluation of a POD in the comfort of one's home, or conveniently in a store that does not have the space requirements to offer a complete diagnostic system. While the PED does not have an integrated device inventory vault, like many of the other previously described embodiments of the applicant (kiosks, etc.), a separate vault may still be used as described in the '533 Application. Some embodiments according to this disclosure may expand many of the services offered in the evaluation systems described in the '533 Application and other applications mentioned above, including, for example, one or more of device evaluation and valuation for a carrier trade-in program, multiple disposition options for evaluating and valuating on a plurality of buyers and markets, determination of insurability, determination of claim validity, estimation of repair material, estimation or repair costs, so that they can now be offered not only in more stores, but also through online entry points, through app download entry points, or pre-loaded on new smartphones.

Example embodiments allow for more convenient and efficient POD trade-in experiences. For example, a user can use another device—which may be a newly purchased device (e.g. new smartphone)—at home to get a guaranteed price for a trade-in POD and mail the POD or use pickup services. The user can get a price at home and drop the POD off at a kiosk with vault in a nearby store (carrier, or UPS store for example). Stores can use technology to offer valid trade in services without full kiosks. Stores can use technology to offer quotes, then allow user to confirm later on before mailing in the POD.

### Large Devices

Some embodiments described herein, by using a PED that is movable in space, provide the capability of performing visual inspection on a much wider variety of devices, including large electronic devices such as laptops, computers, computer screens, TV, appliances, and even larger devices such as on-board electronics (e.g., entertainment and/or navigation systems, etc.) of vehicles. While some of these devices may or may not have ability to execute mobile applications or web-based diagnosis applications, they sometimes are able to execute or be operated in predetermined ways by a user for further determination of the device's health.

Many of the large devices may provide means for the equivalent of an application to be executed. For instance, computers, laptops and smart TVs are able to execute some applications or make use of web technologies. Similar, adapted, diagnostic functions would be used allowing the evaluation devices to go further than visual inspection, and could, for example, perform in-depth analysis of the screen, such as hard to see defects, capabilities and probable malfunctions.

As for larger devices, for instance, a vehicle on-board diagnostic features may be used in order to communicate information about a vehicle diagnostics to an evaluation system. While may on board diagnostics are wired, an interface would be necessary to permit communication between the wired on-board interfaces and the evaluation system, some on board diagnostics make use of vehicles' Bluetooth, LTE or 5G capabilities for example, and are able to connect directly to evaluation systems described herein, such as, for example, the PED, in order to exchange diagnosis information.

### Audio and Other Evaluation

Embodiments performing audio tests using an evaluation device (portable, such as, PED described above, or fixed) may do so by playing an audio signal (such as a recorded sequence or programmatically generated pattern), either in recorded or generated form, such as a white noise or frequency sweep, which allows the evaluation system, by having the evaluation device microphone record or analyze the received signal, to determine frequency response data. While the sound may be emitted from the POD, it may be preferable to use the evaluation device audio speaker in order to better determine the source of a probable problem (e.g., if the speaker of the POD is used to play the audio signal, it may be faulty and create a false positive failure). The speaker of the evaluation device may be presumed to be good, however, an evaluation technique could allow for example, a self-evaluation of the evaluation device (e.g., a self-check) to precede the evaluation of the POD, in order to ensure the audio capabilities of the evaluation device are working adequately. In such an embodiment, to test the microphone of the POD, the audio signal is emitted by the evaluation device speaker while it is positioned at a known approximate distance from the POD, the POD microphone would record the audio signal, and results of an analysis (by the POD or another computing entity) of the recorded audio signal may be used to determine if the audio signal is good. Some embodiments may operate the evaluation device's microphone so that it records or analyzes the signal simultaneously in order to validate that the test was made using a good working evaluation device. Embodiments analyzing an audio signal may do so in real time, for example if the analysis process is made on the device connected to the microphone, in quasi-realtime, for example by a remote server receiving in quasi-realtime the audio signal, or deferred, for example when the audio signal is recorded and analyzed after recording. The analysis process is organized to determine the validity of the signal for example by analyzing the amplitude of a signal, probably analyzing over a plurality of frequencies or frequency-range, and probably comparing the measured points or ranges to a template, which may be a generic frequency-amplitude template or a device specific template, based on the anticipated frequency-amplitude measurements for a given model. Because of the analogous nature of the playback and audio recording, tolerance are added accordingly.

### PED as an Extension to Evaluation System

Embodiments described herein provide for alternative front-end devices to perform many of the tasks previously performed by dedicated, or semi-dedicated equipment, as disclosed for example by the Applicant's previous applications mentioned above, including full fledge kiosks, low-cost apparatus, and the like. The embodiments described herein would rely on some technologies already developed, or adapted, in order to provide users with a plurality of services that require thorough diagnostics, evaluation, inspection, and for some, valuation, including device trading, device valuation, device protection, device repairs, etc.

By using PEDs and the technologies and methods previously and herein described, it is now possible to perform, using a mobile device, in-depth evaluation and assessment of another device (e.g., such as POD described above), including its visuals conditions, health conditions, statuses (such as, for example, finance lock, account lock, blacklisted). A user may use this technology and within minutes, perform an evaluation using the PED and its application, which may work in conjunction with other components of the evaluation system (e.g., defect analysis, device estimator, human operators/agents, artificial intelligence agents, report generation, notification services, etc.) and provide the user with a full-fledge evaluation information, which may contain one or more report and/or information, including market valuation information for similar devices.

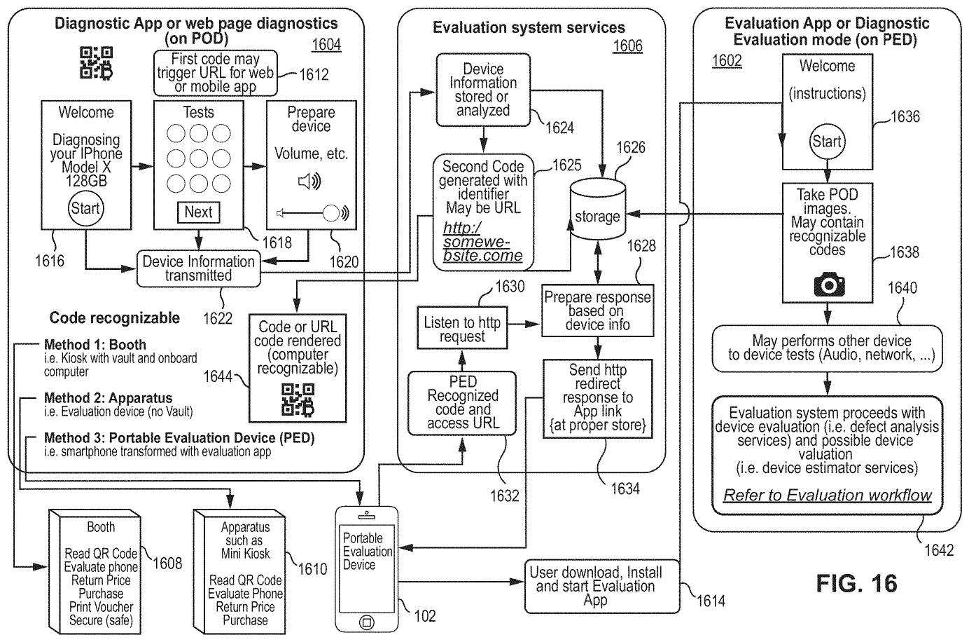

FIG. 16 shows an exemplary embodiment of some methods described herein.

Using combined applications and/or web technologies described herein on two devices provides many benefits to allow adequate inspection of POD, but may create processes that are cumbersome to some users. For example, downloading two applications, executing them on two different devices, may create steps that may discourage some users from using the technology. Thus, at least in some embodiments, a simplified or streamlined process may be provided.

Some embodiments may make use of computer recognizable indicators (CRI), that may contain instructions or indications that can be communicated from a first device to a second device, capable of instructing or indicating to the second device as to what to do for starting or continuing with a process. Examples of CRI are:
a QR code displayed on a first computing device with an embedded URL that may instruct, or indicate, to a second computing device to retrieve a certain resource, such as, for example, a webpage or download of an application;
a text based URL displayed by a first computing device and recognizable by a secondary device;
An active NFC (near field communication) capable device, such as a smartphone, kiosk or other apparatus, passing URL information with probable unique identifier to a secondary device or network credentials information, which may be a hotspot network of the NFC capable device itself, such as, for example, a smartphone;
Pairing by having device display a unique text code ABC 123; and
A passive NFC device, such as, an NFC tag, passing a URL information or network credentials information to a secondary device.

Embodiments using CRI may be configured to begin a POD evaluation process by providing the POD, using a CRI, indications to start the process, using web or mobile application methods described herein. For example, a user may scan using the POD a QR code, or place a NFC capable POD nearby an NFC device which may be a kiosk, smartphone or passive NFC device with a readable indicator (for instance URL or network credentials), and the indications communicated by the CRI facilitate access to the proper resource to begin the POD evaluation process for example by providing URL indications such as a web or application URL, or network connectivity indications, which may then redirect to URL indications.

Evaluation of a POD using certain embodiments described in this disclosure require manual handling of two devices: a POD and a PED. Therefore, certain embodiments may require one or more manual processes: The user needs to operate the POD so that the diagnostic application or web technology may gather information, assess features and internal health conditions, hereafter typically stored as device attributes, and the user will need to operate the PED and its evaluation application to perform visual inspections and complementary environmental inspections, such as audio, network, display, etc.

In another embodiment using CRI, a POD device may have performed a first process for evaluating its internal health conditions, for instance, by having downloaded and executed the diagnostic application, or for instance, and, at the end of that first process, a CRI is used for example by displaying a QR code on the POD to be scanned by a portable evaluation device, which causes the portable evaluation device, upon recognizing the CRI, to start the second process, for example by accessing a URL resource such a web page which may be used to redirect to a proper device store, or directly an application URL, which causes for example the downloading of an inspection (or evaluation) application, the execution of the inspection application, or accessing the web evaluation methods. To furthermore facilitate the experience, the CRI may contain an identifier which enables the evaluation system to automatically identify that an evaluation session that begins with a specific POD is being continued using the PED to inspect the external conditions of the POD.

### Report Generation

In some embodiments, an evaluation system utilizes an evaluation device, such as, for example, a PED, for the purpose of creating a report of a POD. The evaluation device may interact with a report generation service to generate the report. The report generation process may integrate in a resulting report at least one of a complete, partial or altered image of the POD from at least one image taken by the PED or another evaluation device. The report generation process may acquire the IMEI of the POD by retrieving the IMEI using software calls to the operating system of the POD or by optical analysis of an IMEI displayed, using a screen shot image of a page displayed by the POD containing the IMEI or by using a camera image of a page displaying the IMEI. Further, the report generation process may also query at least one third party service, using the retrieved IMEI, for the determination of a particular status in relation with the POD, said status can be at least one of blacklist status, a finance lock status or an account lock status. Additionally, the report generation process may furthermore integrate in the resulting report at least one information based on the result of the query to the at least one such third party service.

To avoid fraud related to IMEI reuse, manufacturers are making it more and more difficult for software applications to retrieve IMEIs. IMEI optical character recognition (OCR) techniques may be incorporated in the use of certain embodiments of this disclosure. The evaluation system may provide information or instructions to the user on how to retrieve an IMEI. For operational phones, the instructions could be to dial *#06# which displays the IMEI on most phones in text and barcode format. Alternatively, a similar page is generally available in the Setting parameters of the operating system. Alternatively, for devices that configurations were wiped out, an information page such as the “(i)” (info) button on iOS will provide the user with the IMEI information in a similar way. Any of such pages could be used for scanning by the camera of any evaluation device, including the PED described herein, and, for example, applying OCR techniques or human data entry, automating the retrieval of the IMEI code.

Exemplary use cases may include:
a. A user is instructed by any of the above noted means to get to an IMEI page:
   i. The POD or PED or a website, or information in a text message sent to the POD for example, could request the user to either dial *#06* or go to settings page and place the POD in-sight of the PED
   ii. Request the user to hold the PED so that the POD screen containing the information can be retrieved by the PED's camera
b. Upon recognition of the IMEI by any technique, either by the PED or a server or device operably in communication within the evaluation system, the IMEI is associated with the evaluation session of the POD
c. The user follows instructions to complete the POD evaluation up to possibly a price quote, or a full trade-in instructions.

The above use-case may be used for either full trade-in of the POD, or to get a quote for the POD, in which case this allows for the user to properly transfer and erase data before proceeding with the trade. The system, for example using the PED or website, may provide user guidance to ensure data is properly transferred, backed-up and erased. The PED or other evaluation system, for example, in a store with a kiosk with vault, may be used to perform a final check of data erasure and/or IMEI validation. For example to reduce PII/Customer information issues, some trade-in systems may require or desire that all personal information be erased from the device. In such case, the evaluation system can, using a connectable evaluation device, for example, a PED, make a final trade checkpoint which may include the steps of:
a. Once the user is ready to trade-in the POD, the evaluation system may propose instructions on how to securely wipe data on the POD
b. The evaluation system may then provide instruction for final validation of the IMEI by providing the user with instructions on how to display an IMEI containing page, which may be for example pressing an info button (e.g., the “(i)” button on the lower right corner of iOS devices).

The evaluation system, using the PED, or other connected camera, can retrieve an image of the POD with the IMEI displayed and is able to confirm that the device is ready for final disposition, for example, in one of the kiosk vaults of the evaluation system, or before printing a final mail-in label or proceeding to the device pickup or dropoff.

The report generation process may also include information related to the owner of the POD in the report, may integrate results of health test functions from the diagnostics and/or evaluations, may include defect information obtained from images captured by the evaluation device (computer-assisted or computer (AI)-generated), and may also include valuation information for the POD. Although particular embodiments have been described above, a person of skill in the art having been provided with this disclosure, would appreciate aspects of the different embodiments may be used in various combinations to realize still other embodiments of the POD evaluation system and enhanced services.

FIG. 16 shows an illustrative interaction between a diagnostic app 1604 executing on a POD 106 and an evaluation system that includes a PED 102, an evaluation app 1602 and evaluation system services 1606, according to some embodiments. The interaction also includes a kiosk 1608 or a mini-kiosk 1610 in some embodiments. The evaluation system services 1606 are a collection of services that may be located on the kiosk, mini-kiosk, PED or a central server to which they are connected by a network.

A user of the POD 106 may download an app (or App Clip as described above) to the POD which may display a on its screen an interface such as that shown in FIG. 2 enabling the user to select (by, for example, selecting “yes” in the interface of FIG. 2, indicating that this is the device that is to be sold) the mode in which the app should operate: a diagnostic mode (or the diagnostic app) 1504 will be activated by the user on the POD 106.

In an embodiment, the user may (e.g. at operation 1614) repeat the same download process on to the PED 102, but select, instead of the diagnostic app that is selected on the POD, the evaluation mode (or the evaluation app) 1602 to be activated on the PED 102. Several techniques by which the POD and PED can be informed of the download information are described above in the section “Lack of Dedicated Device”. In the embodiment illustrated in FIG. 16, a first code (e.g. QR code or other computer recognizable identifier) viewed by the camera of the POD initiates the downloading of the app at diagnostic app at operation 1612. For example, FIG. 3B shows the POD viewing the QR code from a website as accessed and displayed on the PED, and FIG. 3C shown the diagnostic app before the screen shown in FIG. 2. FIG. 3D shows another computer recognizable code, in this instance another QR code generated as described below by the POD, displayed on the screen of the POD and captured, as shown in FIG. 3E, by the PED to begin its interaction with the POD.

On the POD. The diagnostic app may operate to collect device information including device identifying information (e.g., make and model, screen type, IMSI, MAC address, etc.), device configuration (e.g., screen type, camera types, network capabilities, type of battery, etc.), and device defect information (e.g., network defects, microphone and/or speaker defects, battery defects, etc.). For example, at operation 1616 the make and model type of information can be detected, and at operations 1618-1620 one or more tests to detect network interface status, battery status, storage status, etc. and one or more tests to detect audio status can be performed as described above. Note that the device information that can be collected by the diagnostic app running on the POD may not include all the device information that is used in the evaluation of the device for trade-in. At operation 1622 the device information collected by the diagnostic app is transmitted to the evaluation system services 1606.

The evaluation system services 1606 receives (at operation 1624) the device information sent from the diagnostic app on the POD and stores the information in storage device 1626.

The evaluation system services 1606 then at operation 1625 generates a second computer recognizable code which may include, for example, QR code and/or a URL. The code may be generated in a manner that is based on, and depends on knowledge of, one or more pieces of the device information reported by the POD at operation 1622. The evaluation system services stores the generated second recognizable code in storage device 1626. The evaluation system services 1606 may, at operation 1625, also instruct the diagnostic app 1604 to display the second computer recognizable code on the display screen of the POD 106. At operation 1644, the diagnostic app displays the second computer recognizable code per instructions received from the evaluation system services 1606. Operation 1644 may, in some embodiments, include generating the second computer recognizable code on the POD using the required device information of the POD as required by the instructions from system evaluation services and then rendering the second computer recognizable code as generated on the POD. In some other embodiments, what is rendered is the on the screen of the POD is what generated by the evaluation system services.

The evaluation of the POD can be continued at any of the kiosk 1608, at a mini-kiosk 1610 or on the POD 102 operating as the continued evaluation device. In each case, a camera of the continued evaluation device can capture the second computer recognizable code displayed ay operation 1644 on the screen of the POD, and thereby access the already gathered information regarding the POD in the system evaluation services 1604.

The booth 1608 would enable the full range of imaging and testing the POD, and also provides a secure bin or vault for depositing the POD after evaluation, acceptance of a trade-in offer and submission of the POD for trade-in. The mini-kiosk 1610 may provide a range of services such as an imaging chamber for capturing more sophisticated images of the POD enabling detection of defects that are not necessarily detectable by the PED. The mini-kiosk, however, may typically not include a vault to securely deposit the POD. In the third alternative, the PED 102 is the continued evaluation device.

The PED 102, at operation 1632 detects the second computer recognizable code displayed on the POD and using that requests (at operation 1630) the evaluation system services 1606 for the correct evaluation app 1502. At operation 1628, the system evaluation services 1606, based on the POD 106 device information sent by diagnostic app and stored in storage device 1626, identifies the appropriate evaluation app (e.g., evaluation apps may be different based on the make/model and features of the POD) 1602. Then, at operation 1634, the evaluation system services, redirects the PED to a location for downloading the evaluation app 1602. By detecting a recognizable identifier displayed on the POD and then using that recognizable identifier to access information pertaining to the POD in the evaluation system services, the PED is able to validate the subsequently established communication connection and also that the POD in sight is the PED in communication.

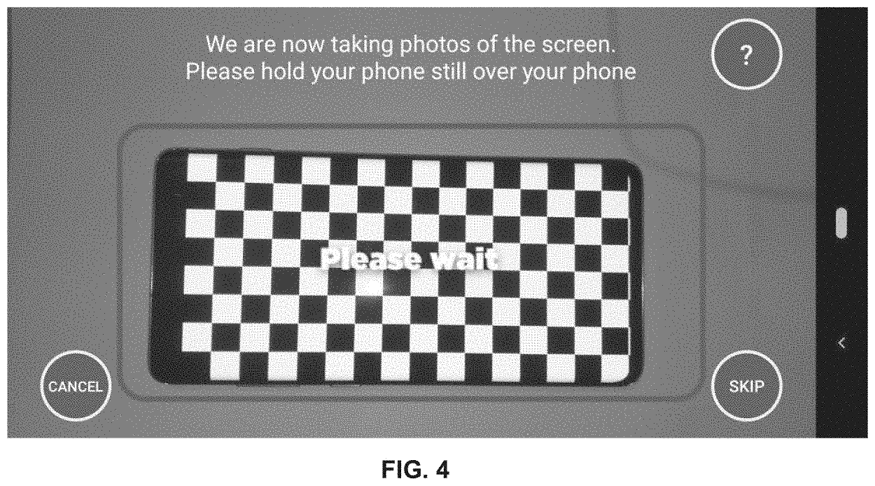

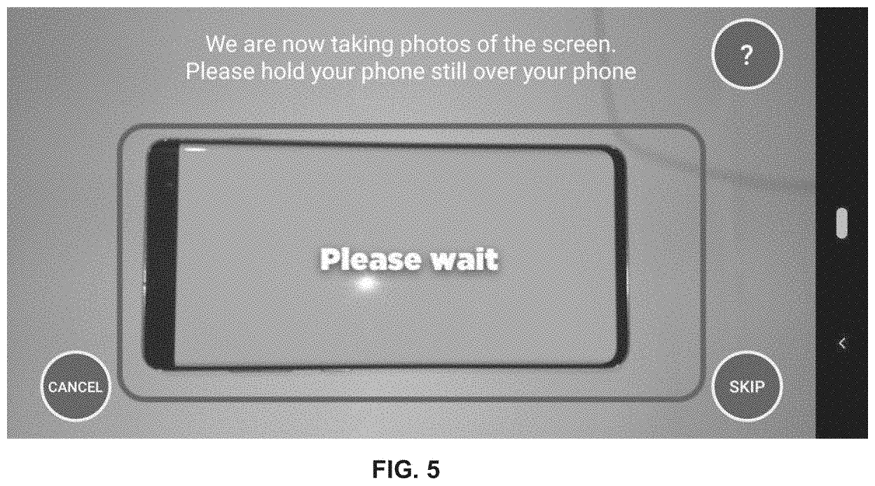

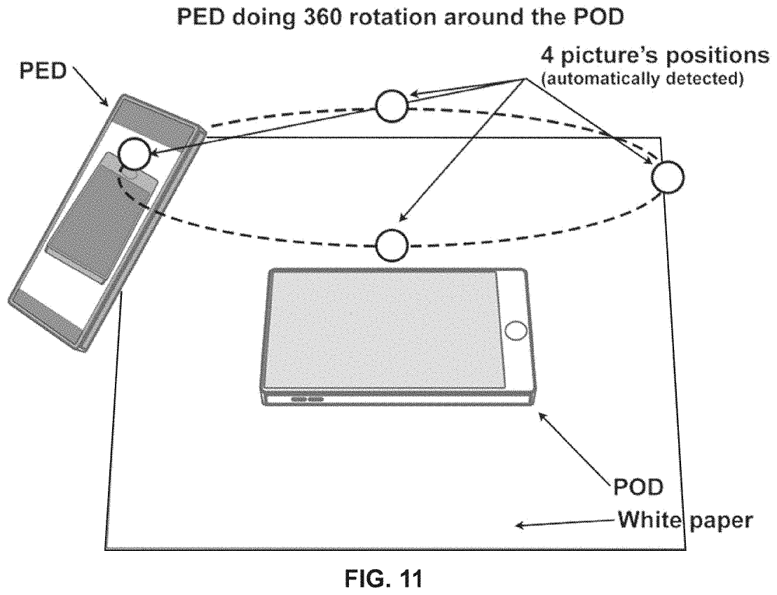

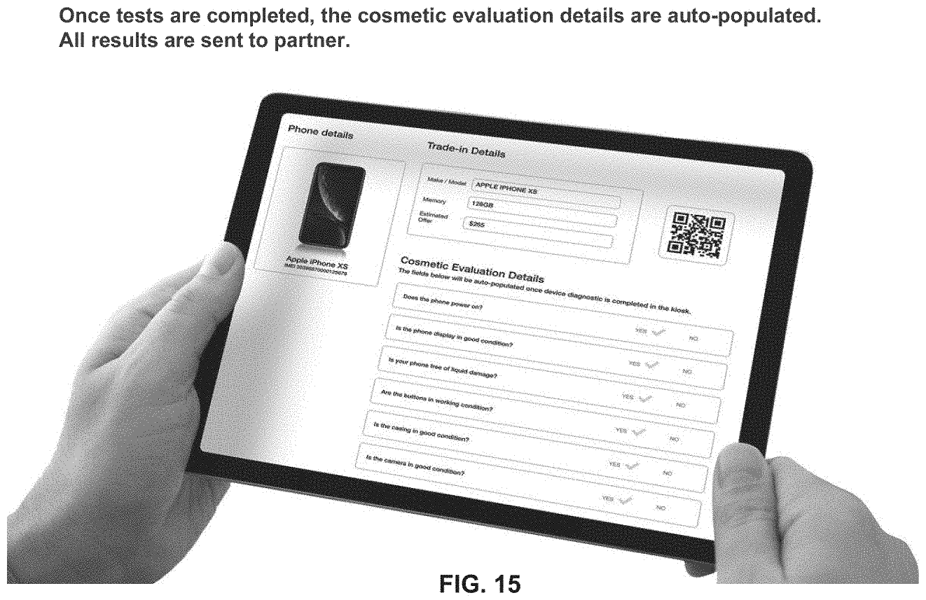

The evaluation app 1602, after starting at operation 1636 (e.g., on PED 102), may, at operation 1638, proceed to guide the user through capturing respective images of preferably each side/surface of the POD as described above (e.g. in relation to FIGS. 3E-3F and 4-14). For example, as shown in FIG. 3E-3F, the PED may capture the computer recognizable identifier (QR code) displayed on the screen of the POD. After the being activated by the QR code displayed on the POD, the user of the PED may be guided to capture images of the POD as shown, for example, in relation to FIGS. 4-14. FIG. 4 illustrates a capturing of an initial photo of the POD by the PED. FIGS. 5-14 show the use of augmented reality (AR) by the evaluation app to show boundaries for positioning the POD for correct image capture for the evaluation. The augmented reality boundaries may be determined and/or adapted based on the detected positioning of the POD as determined by the PED using the captured initial photos (e.g., at FIG. 4). FIGS. 11-13 show example guidance that may be shown to the user on the screen of the PED in order to guide the user through acquiring additional images of the POD by either rotating the PED or the POD around the other. FIG. 15 shows an example screen which may be displayed on the screen of any of the PED 102, booth 1610 or mini-kiosk 1610. The screen shows a portion of the evaluation results, and some of the details of the POD.

At operation 1640, the evaluation app may perform machine-to-machine evaluation of one or more aspects of the POD. For example, the evaluation app may instruct the diagnostic app 2604 to use the POD camera to take images of the screen of the PED 102 when the PED is placed in the line of sight of the POD and a known pattern is displayed on the screen of the PED. Different patterns can be shown and captured so as to detect any deficiencies of the POD's screen. The POD microphone can be tested by the PED playing a predetermined audio pattern and instructing the diagnostic app to record it through the POD's microphone. The POD speakers can be texted by the PED instructing the diagnostic app to play a known audio pattern and recording it at the PED. Other aspects such as the Bluetooth or other network interfaces, status of LEDs, status of camera flash etc., can be detected in similar manner by the PED instructing the diagnostic app to cause a certain action on the POD, and then capturing the POD's action. At operation 1642, the PED may continue the evaluation by accessing defect analysis services and trade-in value estimation services, both of which may be provided by the evaluation app and/or evaluation system services.

Although the above description of FIG. 16 was based on the diagnostic app being downloaded and executed on the POD, similar sequence of operations may occur if the diagnostic services on the POD are performed by a web service accessed from the POD. Moreover, it should be understood that after the evaluation of the POD as described in relation to FIG. 16, further actions may take place in the sequence of operations in a trade-in activity. For example, the booth, mini-kiosk or PED may present the user with an offer price for the POD, provide for generating reports regarding the offer price and/or evaluation, provide for receiving acceptance from the user for the offer made, provide for the user to securely deposit or otherwise handover ownership possession of the POD, provide for providing the user with a payment amount for the POD, etc. Such operations are described more extensively in the applications cited above and already incorporated herein by reference.

It should be also noted that, whereas the second computer generated code displayed on the POD at operation 1644 provides for a reliable means of continuation of the evaluation begun by the diagnostic app 1604 at the booth 1608, mini-kiosk 1610 or PED 102, in some embodiments, the continuation of the evaluation may first, after the diagnostic app, proceed to the PED and thereafter may be continued at the booth 1608 or mini-kiosk 1610 if necessary.

### Relayed and Resumable Pre-Owned Electronic Device Evaluation

Because an evaluation system may comprise a plurality of different corporate customers or partners, such as different carriers and re-commerce companies (phone recycling processing facilities), it may be necessary to not only provide different access points, those of which were described (i.e. kiosks, mini-kiosks, portable evaluation devices, etc.), but it is also possible that, within each of these access points, different customers or different partners have distinct requirements, in the services they offer (POD service providers), how they offer, how they commercialize or brand the experience for their customers.

Some integration mechanisms exist, such as the use of APIs and SDKs and redirection methods to mobile or web diagnostics websites (which may be embodied for example in the form of a web app, or possible combinations of web technologies such as web pages, web services, scripts, etc.). Use of these integration mechanisms may cause certain problems, for example, problems related to configuration management of evolving computer code which may be required to update third party applications regularly. For example, implementing a new test, or correcting a bug in some API could require each of several partners to make adjustments, rebuild, retest, resubmit, etc. Moreover, use of APIs and SDK may require considerable efforts for third parties to develop or replicate functionalities, routines, methods that may be common to many parties dealing with the evaluation system. This is especially true in the implementation of the device-to-device integration, when an application, mobile or web-based, interacts with an evaluation device, for pairing, testing and other methods described previously and herein.

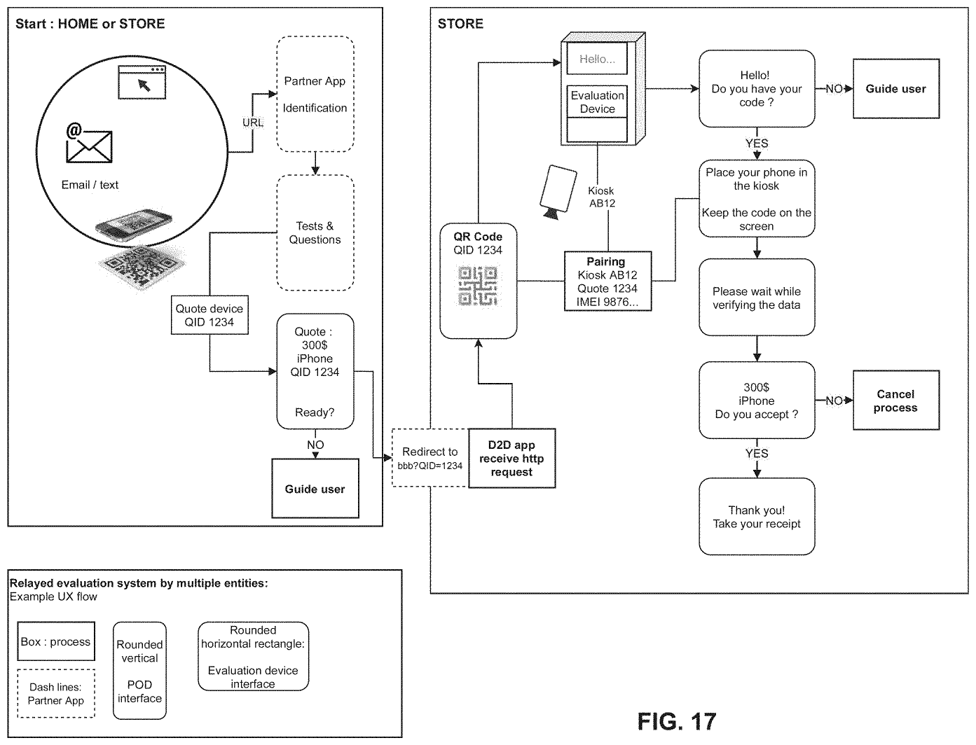

This disclosure, particularly in relation to FIGS. 17-19, describes innovative embodiments that combine some previously disclosed mechanisms with other techniques described herein to provide a seamless integration with third parties. As an overview of an embodiment according to the present disclosure, the inventors describe methods that allow for a previously-owned electronic device evaluation session that:
begins from an access URL or entry point that is intended for a previously-owned electronic device (POD) to access (e.g. download from a store or access an active website, such as a web server running a web-app) an application where a customer journey begins;
continue by the execution of the instructions contained in the application, locally or in a client/server approach (including web techniques);
retain information about a session unicity and optionally other information such as a session status, completed tests, etc., for the purpose of subsequently resuming the evaluation session;
relay the evaluation session to a second application (e.g. a mobile or web-app type);
provide pairing mechanism between at least one the applications and an evaluation device (portable or fixed); and
Enable the evaluation system, once paired with a POD, to perform automated or semi-automated tests, assessment, or capture information about the POD.

Methods for accessing mobile or web based applications are well known.

In an embodiment of the present disclosure, the diagnostic process of a POD may be shared among two or more applications. An evaluation session may refer to a series of other sub-sessions pertaining to the evaluation of a POD wherein the sub-sessions may, or may not, be related to each other.

For instance, the first application used by a user can be accessed in a plurality of ways and provides the starting point of the user experience with the diagnosis system. An access URL may, for instance, be a link to a web page/web application, a app-store download page, an iOS App Clips® or Android Instant App®, in the form of a URL or an URL encoded such as inside a QR code to any such application. This first application can be a third party designed application, and it can be in the form of a mobile or web application (or web app) that may be executed on the POD, or that suggests execution on the POD. This first application may provide a first set of functionalities, such as customer identification and testing, and uses cookies and redirection mechanism to pass on (e.g. transfer information regarding) a user journey to a second web or mobile application.

An Example Use-Case

The following is an exemplary use case scenario shown in FIG. 17 according to an embodiment with selected example entities used, namely using a Partner Web-App, but a closed system App could be used as well:
At an initial time, the owner of a POD is given a URL to a Partner Web-App (possibly QR encoded, and for example on a carrier website, by email, printed, etc.) and accesses the URL. The Partner Web-App or system assigns at least an identifier, such as a Quote ID. A computer recognizable identifier, such as a cookie or other data container now contains an identifier, for example a session identifier or the quote identifier. (Involved Entities: Partner Web-App (1st app), Partner Document (QID1234.json) is created Local POD storage (Cookie, key pair, record, file, etc.));
The owner performs a series of actions as instructed by the Partner Web-App (the first application). (Involved Entities: Partner Web-App);
The Partner Web-App may access internal or external services, such as an integration data flow to data stored on a third party, such as account information stored at a Carrier partner. (Involved Entities: Partner Web-App, Third party service interface to data, Third party servers & databases QID1234.json may contain user info and some device attributes);
The Partner Web-App may perform certain system call queries (e.g., to determine make, model, etc.), automated tests (e.g., determine graphic performance etc.), user assisted tests (e.g., touching areas of the screen etc.) and stores the information in the quote document. (Involved Entities: Partner Web-App, QID1234.json device attributes);
The Partner Web-App may determine a quote value and present such quote to the user, possibly conditional to a later physical assessment. The Partner Web-App may contact the evaluation system for example by transmitting the QID1234.json, and the evaluation system may create an evaluation session document, or use the QID1234.json document, and start associating or including additional information. (Involved Entities: Partner pricing data/servers, Evaluation session);
The POD owner may accept the quote which causes the Partner Web-App to redirect control of the pre-owned device to the evaluation system Web-App. Either of the App may be responsible to guide the user to an evaluation device, which may be for example a kiosk at a nearby store, or a downloadable portable evaluation device.
   a. At the first validated access of the Evaluation System Web-App by a POD (for example following the redirected http request), an Evaluation session (i.e. Session1234.json) may be created with basic information, including associable information to the Partner Web-App instance, in this example Quote ID 1234, which may be done for example by including a copy of the QID1234.json quote object within the Session 1234.json.
   b. One of the app may end at the presentation of a computer recognizable identifier (CRI) that may be recognized by an evaluation device. This displayed interface could be a resume point. At this point, the first ‘web-session’ of the Partner Web-App may be considered terminated, as the user is likely to vacate to other occupations until he is nearby an evaluation device. (Involved Entities: Partner Web-App, Redirection URL, Evaluation system Web-App, QID1234.json, Session1234.json, CRI);
At a subsequent time, the owner of the POD is now nearby an evaluation device, for example having walked to a nearby store, and resumes the Partner Web-App, for example by scanning a QR code, or clicking on a link in an email, text message, etc. (Involved Entities: Evaluation system D2D, Web-App (2nd app), Evaluation device, QID1234.json, Session1234.json, CRI).
The evaluation system Web-App recognizes the evaluation session, for example, by validating the stored identifier in for example the cookie, may verify the validity of the quote (i.e. expiration), and, upon success, resume the user to the instructions containing the CRI and provide the user with instructions on how to present the CRI to the evaluation device camera, for example:
   “Place phone in the inspection area with this QR code facing up [QR CODE]”
   a. From then on, Session1234.json is typically updated with information or references to information or assets regarding each step performed or information retrieved. (Involved Entities: Evaluation system, D2D Web-App, Evaluation device (unidentified), Session1234.json, CRI);
One of the plurality of evaluation devices, for example, evaluation device #AB12, on the evaluation system's network recognizes a CRI, communicates the CRI (and/or the identifier it contains) with the evaluation system service for pairing, and, upon successful association of a CRI with a valid quote or evaluation session, such as Quote ID 1234, the evaluation system associates that a portable evaluation device is now temporarily associated with the POD's related to Quote ID 1234, as an example. The evaluation system, by means of network communication technologies, is now operably in communication with an identified POD associated with an identified evaluation device. (Involved Entities: Evaluation system D2D, Web-App (2nd app), Evaluation device #AB12, Session1234.json (QID1234.json, CRI, Pairing service);
Once the evaluation system is operably in communication with an identified POD and an identified evaluation device, it can begin a security challenge sequence. Note that the pairing and security challenge may be completed in a single secured pairing process. (Involved Entities: Evaluation system D2D, Web-App (2nd app), Evaluation device #AB12, Session1234.json, CRI, Security challenge service).
Operably in communication with the POD and the evaluation device, the evaluation system may make a first physical assessment that “the device quoted using the Partner Web-App quote ID 1234 (for example), is being in physical presence of the evaluation device #AB12 (for example). (Involved Entities: Evaluation system D2D, Web-App (2nd app), Evaluation device #AB12, Session1234.json (QID1234.json), CRI, Security challenge service);
The evaluation device may take digital assets of the POD, such as digital images from one or more angles, lighting conditions, displayed on-screen patterns, etc., and may store or render available such assets, for example, transmitting them on a server accessible to the evaluation system. The Session1234json document would be populated with the assets or references to such assets (such as URLs, filenames/paths, etc.). (Involved Entities: Evaluation system D2D, Web-App (2nd app), Evaluation device #AB12, Session1234json, Evaluation system server/storage);
The evaluation system may perform automated tests, for example, it may demand the POD to play a frequency sweep while the evaluation device listens to the audio signal to assess its presence and quality, and store results or references into Session1234json (Involved Entities: Evaluation system D2D, Web-App (2nd app), Evaluation device #AB12, Session1234json, Evaluation system server/storage);
Once the physical assessment is completed, the user may be presented with a service confirmation page, which may be personalized for example using a personal information contained in the Quote object, for example:
   Hi Scott,
   You have been quoted
   456$ for your iPhone X.
   Please confirm your
   acceptance of the trade
   T&C
   a. Acceptance (or refusal) by the owner would be stored in Session1234.json. (Involved Entities: Evaluation device #AB12, Session1234.json);
Presuming acceptance, the evaluation device may:
   a. If equipped with a vault, perform the secure placement of the POD in the vault,
   b. If a portable evaluation device is used by the owner, instructs the user how to package and ship the POD, or
   c. Otherwise demand a local store personnel to continue with securing the traded device process accordingly, which may be using a detached vault operatively part of the evaluation system that could be located, for instance, in an employee area;
Upon the best confirmation that the POD is now either in transit or secured in a vault or otherwise, the evaluation system could notify for example using a webservice to a partner backend server, for example, with a message “confirming device 1234 is secured in vault of kiosk #AB12”;
Consequently, the evaluation system may cause the transmission or printing of a receipt for the owner confirming certain details of the transaction.

The quote referred herein may be any of a quote price, a quote price range, a quote for a protection plan for the device, a quote for repair estimation details, a device grading, a device score in that the quote provide either a value for the POD service offered (i.e. trade-in value, monthly installment plan, etc), or specific information about the quoted device.

A First Example Application

A first example application of the resumable evaluation session described herein may be a customer or partner application that is branded, or provide a specific journey, or connects to specific third party services or databases. For instance, a re-commerce company may have an application developed to provide trade-in services to specific carriers, and have already developed methods to access the specific carrier database, for instance, to retrieve customer information. The first application may also be designed as a ‘vanilla’ application of the evaluation system. What matters in the current embodiment is that it has the ability to retrieve some of the information needed to complete the evaluation session, and has the ability to render available such information to the evaluation system, by means of transmitting or providing services to access, possibly using server to server web services communications.

A typical embodiment of such first application may be implemented as follows:
The application identifies the user;
The application retrieve information about the user and/or the POD it is being executed on;
The application stores locally a unique identifier, which may be for example, a session ID or a key for later association, which may be stored such as by using a web-cookie or information stored in a keychain, alternatively, a key or session ID may be contained in a URL, however, that method would be less secure as it would easily allow a person to copy the URL so that the tests is continued on a second pre-owned electronic device;
Once the first application has completed its specific journey with the customer, it may present instruction to continue the journey for example at one of the carrier's location, where an evaluation device is present, alternatively, it could present instructions enabling the user to continue the journey using a portable evaluation device, for instance using a new smartphone received from an online purchase;
To integrate with the services of the evaluation system that make uses of device-to-device interaction for cosmetic evaluation, testing and other assessment, the first application may redirect, for example using a URL redirect that contains an associable identifier, such as the session ID or quote ID, to a second application, mobile or web-based;
The first application may render to the user some information about the POD service providers requiring an evaluation, for instance, it could provide a quote for trading in the POD against a new device at a carrier's facility, or online, or provide a quote to repair the device, or a quote to insure (or provide protection plan) the device, etc., the services generally being conditional to completing the evaluation session using an evaluation device, which may be located at a carrier store, for instance using a kiosk, or downloaded or installed on a portable electronic device; and
The first application must now render available at least some of the information collected, such as device attribute IMEI, and/or make and/or model, and possibly any other useful information to the evaluation system, possibly by means of transmitting the information to the evaluation system, to a server on its own domain, or possibly any other server such as a cloud server accessible by both entities (the partner company and the evaluation system operating company).

The associable identifier described herein may be any existing or newly created identifier used in the context of accessing the information contained in the first session at a later time, such as during the second session. The associable identifier can be POD related such as the IMEI, the MAC address, a serial number, or randomly created during the first session and digitally or manually communicable such as a unique printable and typable code, a cookie, a key pair value, etc. The associable identifier can also be related to the owner, such as a cellular number, an account number, an email, etc. The associable identifier can be retrieved programmatically such as capturing the IMEI with OCR means, the MAC address by means of extracting information contained in the low-level network packets, by means of system calls, etc. The associable identifier can also be communicated manually such as by printing a coupon, etc.

It is generally here that the evaluation session is first suspended, for example because a user started the evaluation session at home to get a quote for its pre-owned electronic device, and would likely resume for continuing the trade of its POD in a store associated with the carrier.

In an embodiment, the first application may be resumed any number of times because it has stored, locally or remotely, information such as a status or session information file, for example a session.json file may contain:

```
Session1234.JSON:
  {
    ″Sessions″:{
      ″SessionID″ : ″S1234-1″,
      ″QuoteID″ : ″QID1234″,
      ″D2DSessionID″ :″D2D1234-2″
    },
    ″Dates″ : {
      ″QuoteReceived″ : ″2020-10-01″,
      ″Paired″ : ″2020-10-02″
    },
      ″QuoteInformation″ : {
        ″QuoteID″ : ″1234″,
        ″Quoted″ : ″2020-10-01″,
      ″Expiration″ : ″2020-10-15″,
      ″DeviceInformation″ :{
        ″Make″ : ″Apple″,
        ″Model″ : ″iPhone X″,
        ″Storage″ : ″128″,
        ″IMEI″ : ″12345678098765″
      },
      ″Offer″ : ″300.00$″
    },
    ″Status″ : {
      ″Paired″ : {
        ″Status″ : ″OK″,
        ″DeviceInformationMatch″ : true,
        ″Method″ : ″SecurityChallenge2″,
        ″Key″ : ″ABhy-128j-9j33″,
        ″With″ : ″AB12″
      }
    }
  }
```

The use of JSON data format in the present disclosure is provided as an example and easy way to capture device attributes, as previously described.

It is important to note that for the evaluation system to function properly, the session information should at the very least permit unicity and make and/or model information retrieval, therefore, such information could be the IMEI only because it is unique and is associable with a device manufacturer and model and more. However, because IMEI retrieval may be difficult on most mobile platforms, it is not desirable to have the retrieval of the IMEI more than once, and the Session ID, which refers to an authentic IMEI, may be among a preferred embodiment.

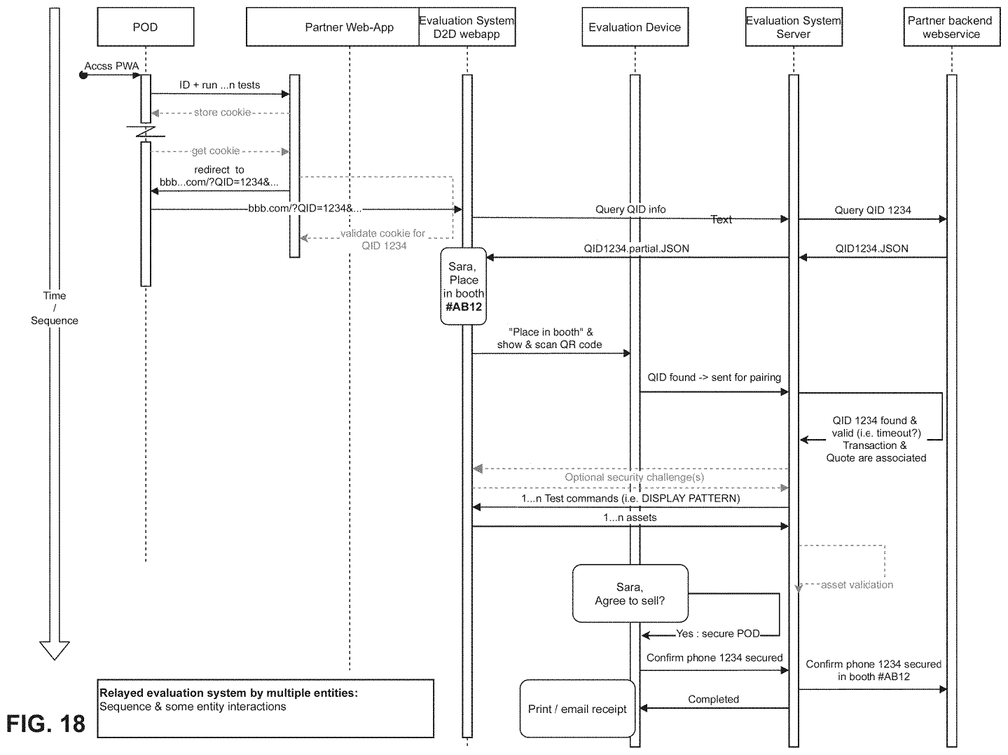

In one of such embodiment, a web-cookie or key pair record may be used to store a Session or Quote identifier, which may be used to communicate back and forth information between the various entities, such as the entities described in FIG. 18.

While the first application may not, at least entirely, be considered part of the “evaluation system”, because it has for example branding specifics or may provide services that are outside the scope of the evaluation, the second application is, in these embodiments, undoubtedly part of the evaluation system. However, the functions of the first application pertaining to the evaluation of the device are part of, or are entry points to, the evaluation system.

A Second Example Application

An example second application may also be in the form of a mobile or web-based application that is also intended to be executed on the pre-owned electronic device. The second application specializes in device-to-device (D2D) communication, for pairing, security validations, asset taking and automated testing. When the second application is accessed, typically by having been redirected by the first application to a website URL, such as, for example, if instantiated as a web-app: ACMEtradepartner.buybackbooth.com/SecondApp, a key feature of the second application is to provide a computer recognizable identifier, for example by displaying a QR code, that will be recognizable by an evaluation device for pairing purposes, as furthermore described herein.

Embodiments of this invention may uses one or more security layers, by storing a local key, such as by using a cookie or key pair or similar method, typically accessible by both the first and second application, and possibly encrypting or hashing such key for rendering it unusable on another device, for instance using a serial number of the pre-owned electronic device. This security layer serves at least two purposes: ensure that the user does not mistakenly resume the app, in the case of a web-app, on a second device, as well as preventing malicious users from doing so with a malicious intent (e.g., getting a high value quote on a good device, but attempting to continue the trade-in with a lesser value device, etc.).

The second application has the core functions related to the device-to-device interaction between the POD and the evaluation device. The second application is typically used to pair the devices, capture assets, such as digital images of the POD, and other information such as may be stored as device attributes, and are meant to become part, directly or indirectly, of the evaluation session details.

For clarity, the evaluation device may also be implemented as a web technology or mobile application, as described in previous applications but namely as a portable application device or for the mini-kiosk, however, such application would be a third application in the current context. In the current context of the embodiments of the invention described, both the first and second applications are intended to be executed on the pre-owned electronic device.

In an embodiment of the invention, the second application may receive, probably as the redirection URL when the first application is now ready to continue with device-to-device interactions, and within that URL, a URL parameter that is an identifier that may be a session ID, a POD identifier, or any other identifier associable with a POD or its owner (user). As an example, the URL could be:

ACMEtradepartner.buybackbooth.com/SecondApp?ID=QID1234.

In such embodiment, the identifier “ID” is used by the evaluation system to retrieve information about the evaluation session 1234. For example, it may query, directly or using intermediary services (i.e. web services or other intermediate servers/apps), a service interface of the third party partner system for retrieving a quote information that was originally provided to the owner of the POD. For example, it may retrieve a QID1234.JSON file that contain all or part of the information collected about the evaluation session related to quote #1234. The evaluation system, including the second application may then use information contained in the QID1234.JSON file.

Alternatively, some embodiments may store the identifier as a quote ID or session ID or other identifier inside a cookie or key pair record or similar local storage, wherein such cookie is made accessible to at least one server on the domain of the evaluation system, or, alternatively, as a server on the domain of the partner company, which server would have the ability to communicate or relay information with servers of the evaluation system.

Alternatively, the quote ID may be provided as a URL parameter as described above, but a security key is stored inside a cookie or key pair record or similar local storage, and such key is rendered accessible to the evaluation system to authentify that the quote ID 1234 was indeed made using the same device that is now utilizing the second application.

While the second application is mostly directed toward device-to-device interaction, it may still need, in some embodiments, to provide a basic user interface. In some embodiments, the user interface may be as simple as displaying a message to the user to ‘Place the phone in booth’ or ‘Place the phone in front of the evaluation device’, along with a computer recognizable identifier (CRI), that the evaluation device will use to begin the pairing methods or security challenge methods described in previous applications.

In some embodiments that provide trade-in services, payment for a POD may be a payment of in-store credit, printed using a printer operable by the evaluation device, emailed to a user address, texted to a user phone number or otherwise sent.

In other embodiments that provide trade-in services, payment for a POD may be posted electronically to a customer account, for example, through or by a partner that may apply credit to a cellular account in relation with the owner of the traded POD.

Defect Detection and Device Grading

In some embodiments of the invention, once the POD has been paired and some assets or tests results made available to the evaluation system, it may begin the various processes and methods described in prior applications for defect finding, grading and sometime pricing devices.

In some embodiments of the invention, the evaluation system, when having detected changes between the quoted device information and the actual physically assessed device information, may alert the user of such changes, and provide an alternate, conditional or modified quote.

It is possible that some implementations assume a high level of trust toward the quote device information, for example, because the first application asked the user if there were any defect, and providing a quote only valid if this is true at the time the device will be received by the processing partner. This may become viable, for instance, when payments are posted or sent electronically after the device is received at the processing partner facility. By trusting the user response, a benefit may be to reduce the defect finding, grading and re-pricing burden of the evaluation system, which may require human operators for performing at least some tasks. Such evaluation systems would provide posteriori, on-demand evaluation services or reporting for devices that have been presented to an evaluation device, but not inspected, at that time, for all defects, namely visual defects. The benefits of such system is that the burden associated with visual defect identification, which may be substantial, would only be required for devices received by a processing facility that presents one or more discrepancy between the physical device and the quoted information. Retrieving the assets, and activating the inspection process only at that time, allow for a better dispute resolution because the processing company may assess (i) was the defect present at the time the device was presented to the evaluation device, in which case the user-owner should be notified and a probable lower payment issued, otherwise, the defect has been generated during handling or shipping in which case the user-owner should not be involved in a dispute, and (ii) if a dispute is required, the processing company has the relevant assets (proofs) that the device was not in the disclosed (quoted) condition, and therefore it is less likely that the user-owner will argue, and less likely that the user-owner will file some complaint, including social media reviews.

A typical use case of a dispute may start as follows:
An operator at the incoming devices group of a processing company assess that a received device is not in the anticipated condition;
The operator access the dispute access point, for example through a web portal, or triggers a certain function in a test software, and may requests either to access the digital assets directly, or cause an inspection to be triggered (such as using the evaluation system defect analysis services), or require a full evaluation report;
The evaluation system, returns the desired information, in real time whenever possible, or at a later if a delay is caused by the inspection process;
After reviewing the information, the operator or the evaluation system may assess that the defect was existent or not, at the time the device was presented;
The operator may follow a dispute process, accordingly, which may cause for example an email to be sent to the user-owner, with relevant information about the status of the device, for example highlights of the defects on an evaluation report, and may provide the user-owner with a revised, modified quote, or otherwise handle the dispute.

In such implementations, some embodiments of the invention may be implemented so that the evaluation system store all assets and tests results for future retrieval, inspection and/or reporting, but do not perform, at the time the POD is presented to the evaluation device (system) perform any inspection including any defect finding, or device grading or pricing.

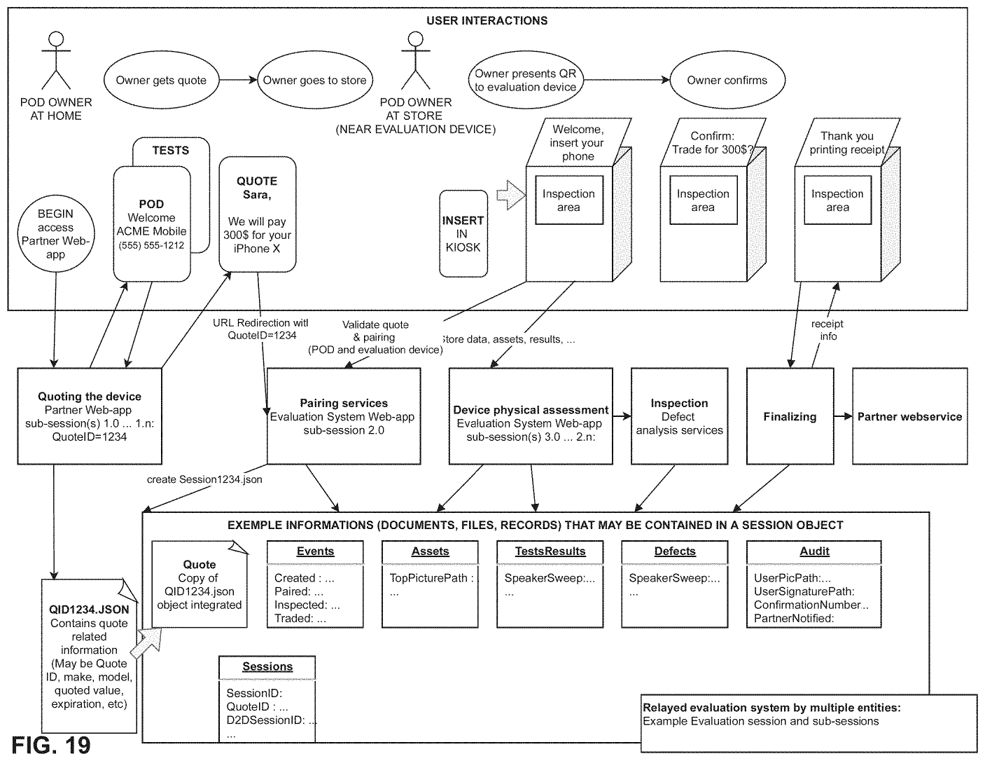

Such embodiments could provide dispute access points instead which may be used by a partner to access the evaluation system once the POD is received and matched with the quoted information and a discrepancy is identified either manually or by an automated process in place at the processing facility. In such case, a dispute access point could be used to trigger the evaluation system to retrieve the associated information, assets (i.e. such as pictures) and tests results, or parts of, so that the discrepancy may be evaluated with factual information available at the time the owner of the POD allowed the evaluation device to perform the capturing of the digital assets. In such embodiments, the “Inspection process” and the “Defects list” (see FIG. 19) are not used/existent until a request to inspect the device comes in at a later time. Typical instantiations of a dispute access point would be one or more of a human accessible web-portal, software accessible web services or the likes for integration with software applications possibly embedded into incoming device reconciliation and/or testing software, a mobile application and the like. The dispute access point is to be used by personnel, or automated software calls, when information about a POD at the time the POD was presented to the evaluation device is necessary or helpful to either avoid a dispute or manage a dispute with the user-owner.

Conditional Redirection

Some embodiments of the invention may be implemented in a way that the first application may select from a plurality of possible second applications the one that is best suited for a particular situation, such as a service selected (trading in, repair estimation, etc.) or one or more POD attribute(s). It may be desirable, for instance, to direct POD evaluation sessions for POD valued under a certain threshold to web-based diagnostics, which are less cumbersome for the user to install, but direct higher than threshold values POD to a mobile application that is able to perform more tests and therefore reduce the risk that an incorrect evaluation be performed by the evaluation system.

In relation to the description above, in one aspect an embodiment may provide for protecting the relay of the multiple sub-sessions by use of URL redirection and device pairing. For example, a method for providing a resumable device evaluation session for a pre-owned electronic device using an evaluation device within an evaluation system, wherein, in order for the evaluation system to associate that a resumed device evaluation session is resumed, the method comprises the steps of:
Capturing, using a first mobile or web application (the first application) by means of user interaction or system calls, at least one device attribute about the pre-owned electronic device, the attribute being sufficient to directly or indirectly identify a model make or model or a user;
Storing at least one uniquely traceable information on the pre-owned electronic device for tracking or resuming the device evaluation session at a later time;
Redirecting the user, using a URL, from the first application to a second mobile or web application (the second application);
Using the second application to display on the screen of the pre-owned electronic device, or transmit, by means of near field communication a computer recognizable identifier directly or indirectly associable with the pre-owned electronic device, its user-owner, or its evaluation session;
Capturing the computer recognizable identifier, using either a camera or a near field communication method on a portable or fixed evaluation device; and
Pairing the pre-owned electronic device and the evaluation device by association of the captured computer recognizable identifier and the device evaluation session.

Additionally, also in relation to the description above, an embodiment may provide for protecting the dispute access point method that “allow for inspection on demand” only. An example method for providing an on-demand, posteriori device evaluation service for a pre-owned electronic device within an evaluation system, wherein the method may comprise the steps of:
Capturing, using a first mobile or web application (the first application) by means of user interaction or system calls, at least one device attribute about the pre-owned electronic device, wherein at least one attribute is sufficient to uniquely identify the pre-owned electronic device, and wherein at least one attribute, which may be the same, is sufficient to directly or indirectly identify a model make or model of the pre-owned electronic device, or a user;
Quoting a price for the device or for servicing the device based at least on the one device attribute; and
Taking at least one digital image of the pre-owned electronic device for capturing the pre-owned electronic device physical condition at that time.

While the embodiments presented herein have been described in detail, the foregoing description is in all aspects illustrative and not restrictive. It is understood that numerous other modifications and variations can be devised without departing from the scope of the disclosed embodiments.

What is claimed is:

1. A portable evaluation device comprising:
at least one camera;
a memory;
at least one network interface; and
at least one processor configured to:
capture, using the at least one camera, a computer recognizable identifier displayed on a screen of a previously-owned electronic device (POD);
establish a wireless communication connection via the at least one network interface to the POD;
validate the established wireless communication connection by comparing the captured computer recognizable identifier and a stored computer recognizable memory accessed from the memory or from an evaluation service;
responsive to the validation, perform machine-to-machine evaluation of the POD to determine a condition of the POD; and
communicate a result of the evaluation over a communication network to a central server and/or to an electronic device evaluation kiosk.

2. The portable evaluation device according to claim 1, wherein the portable electronic device is a smartphone or a tablet computer, the wireless communication connection is a Bluetooth wireless connection, and the communication network is a wide area network.

3. The portable electronic device according to claim 1, wherein the at least one processor is further configured to capture, using the at least one camera, a second computer recognizable identifier displayed on the POD, and wherein the validation further comprises comparing the captured second computer recognizable identifier and a transmitted second computer recognizable memory stored in the memory.

4. The portable evaluation device according to claim 1, wherein said perform machine-to-machine evaluation of the POD to determine a condition of the POD comprises:
transmitting commands, from a first application executing on the portable electronic device, to a second application executing on the POD; and
obtaining results of one or more operations performed by the second application in response to the commands.

5. The portable evaluation device according to claim 4, wherein the commands include one or more commands to display one or more images on a display of the POD.

6. The portable evaluation device according to claim 4, wherein the one or more images include an IMEI of the POD.

7. The portable evaluation device according to claim 4, wherein the commands include one or more commands to play a first audio signal over a speaker of the POD or record a second audio signal using a microphone of the POD.

8. The portable evaluation device according to claim 4, wherein the commands include one or more commands to capture one or more images using a camera of the POD.

9. The portable evaluation device according to claim 4, wherein the commands include one or more commands to display a sequence of lighting on one or more lights of the POD.

10. The portable evaluation device according to claim 4, wherein the commands include one or more commands to measure a battery of the POD.

11. The portable evaluation device according to claim 1, wherein the at least one processor is further configured to:
display a sequence of instructions on a display screen of the portable electronic device, wherein the sequence of instructions includes respective instructions to change positions of the portable evaluation device and/or the POD such that respectively different sides of the POD are visible through the camera of the portable evaluation device;
in relation to each instruction in the sequence:
monitor a correspondence between an image of the POD and a respective guide image on the display screen; and
in response to a predetermined level of correspondence between the image of the POD and the respective guide image,
capture at least one image of the POD; and
perform a portion of the evaluation based on the captured images to determine at least a portion of the result.

12. The portable evaluation device according to claim 11, wherein the at least one processor is further configured to:
obtain an offer price for the POD based at least on the result of the evaluation; and
display of the offer price on a display of the POD.

13. The portable evaluation device according to claim 1, wherein the at least one processor is further configured to, response to the validation, access self-diagnosis results obtained by the POD.

14. A pre-owned electronic device evaluation system comprising:
a portable evaluation device according to claim 1; and
a pre-owned device evaluation kiosk comprising one or more cameras arranged in an evaluation chamber and at least one processor configure to:
capture, using the at least one camera, a computer recognizable identifier displayed on a screen of a previously-owned electronic device (POD) located in the evaluation chamber;
based on the computer recognizable identifier, access self-diagnosis results obtained by the POD;
based on the computer recognizable identifier, receive the result of the evaluation performed by the POD; and
control said one or more cameras to perform further evaluation of the POD.

15. A system for providing, for a previously-owned electronic device (POD), at least one POD service resulting from a POD evaluation, wherein the system comprises:
a first evaluation device configured to, based on a first access URL that uses a first software application in the form of web or mobile technology, execute instructions of said first software application providing for the POD, based on a first evaluation of the POD, a first result including at least one of a trade-in quote price or price range, device grading, device evaluation score, protection plan payment details, or repair estimation details; and
a second evaluation device, different from the first evaluation device, operatively in communication with a camera and configured to execute instructions of a second software application to perform a further evaluation of the POD and perform, in consideration of the first evaluation and the further evaluation, one or more actions in relation to the POD service.

16. The system according to claim 15,
wherein the first evaluation device is configured to:
start the transaction using the access URL in a first evaluation session; and
retain session information containing at least one associable identifier associated with at least one of the session, the POD or the owner and quote information,
wherein the second evaluation device is configured to:
use the camera to capture at least one digital image of the POD in a second evaluation session;
associate, based on the at least one associable identifier, accessing the quote information from the first session; and
confirm, using the at least one captured digital image of the POD, the validity of the quote information, and, upon positive confirmation, present a service confirmation page and, upon final acceptance by an owner of the POD, communicate with a service partner or service provider.

17. The system according to claim 16, wherein the second evaluation device is configured to communicate with the service partner or service provider using a predefined interface, and the predefined interface is configured to obtain, from the service partner or service provider, at least one of information for trade-in of the POD against value, information for subscribing to a protection plan for the POD, or information of repair estimation.

18. The system according to claim 15, wherein the POD service includes any of a trade-in the POD against value, subscribing to a protection plan for the POD, or obtaining repair estimation.

19. The system according to claim 15, wherein the second evaluation device is an evaluation kiosk.

20. The system according to claim 15, wherein the second evaluation device is a portable evaluation device including the second software application as a mobile application software.

21. The system according to claim 15, wherein the first evaluation device is a portable evaluation device and the second evaluation device is an evaluation kiosk.
